(19) United States
(12) Patent Application Publication
(10) Pub. No.: US 2016/0241998 A1
(43) Pub. Date: Aug. 18, 2016

(54) METHOD FOR CONFIGURING GEO-FENCE AND ELECTRONIC DEVICE THEREOF

(71) Applicant: Samsung Electronics Co., Ltd., Gyeonggi-do (KR)

(72) Inventors: Areum CHOI, Gyeonggi-do (KR); Woo-Young Kim, Gyeonggi-do (KR); Jeong-Min Park, Gyeonggi-do (KR); Sunggyu Lee, Gyeonggi-do (KR); Jae-Woong Chun, Gyeonggi-do (KR)

(73) Assignee: Samsung Electronics Co., Ltd.

(21) Appl. No.: 15/046,112

(22) Filed: Feb. 17, 2016

(30) Foreign Application Priority Data
Feb. 17, 2015 (KR) 10-2015-0024293

(51) Int. Cl. H04W 4/02

(52) U.S. Cl. CPC H04W 4/021

(57) ABSTRACT

A mobile electronic device is provided. The mobile electronic device includes an electronic device housing; a non-cellular communication module contained in the electronic device housing; a battery contained in the electronic device housing; a processor contained in the electronic device housing and electrically connected to the non-cellular communication module; a user interface operatively connected to the processor; and a memory electrically connected to the processor, wherein the memory stores instructions that, when executed, cause the processor to receive a first variable identifier and a first unique identifier from a first wireless signal generator in a geographical area including a plurality of wireless signal generators through the communication module, provide the first variable identifier through the user interface, associate the first variable identifier with a first point of interest and storing the association in the memory, receive a second variable identifier and a second unique identifier from a second wireless signal generator among the plurality of wireless signal generators through the communication module, and automatically associate the second variable identifier with the first point of interest, based on whether or not the second variable identifier is the same, at least in part, as the first variable identifier, and store the association in the memory.

### PRIORITY

This application claims priority under 35 U.S.C. §119(a) to a Korean Patent Application filed on Feb. 17, 2015 in the Korean Intellectual Property Office and assigned Serial No. 10-2015-0024293, the entire content of which is incorporated herein by reference.

### BACKGROUND

1. Field of Disclosure

The present disclosure relate generally to a method of configuring a geo-fence in an electronic device and an electronic device thereof, and more particularly, to an apparatus for and a method of configuring a geo-fence based on variable identifiers of one or more wireless signal generators in an electronic device.

2. Description of Related Art

With the development of information communication technology and semiconductor technology, various electronic devices have been developed into multimedia devices for providing a variety of multimedia services.

An electronic device may configure a geo-fence to provide a location-based service, such as an advertisement service, to electronic devices that are located within an area fenced by the geo-fence.

An electronic device may configure a geo-fence by using a certain wireless signal. For example, in the case where an electronic device configures a geo-fence based on a media access control (MAC) address of a certain access point, the electronic device may determine an entry into the geo-fence according to a reception of a wireless signal that contains the MAC address of the corresponding access point. However, when the electronic device is disconnected from the access point that is configured as the geo-fence and then is connected to a new access point, the electronic device may recognize a different geo-fence because the MAC address has been changed due to the connection with the new access point.

### SUMMARY

According to an aspect of the present disclosure, an apparatus for and a method is provided for configuring a geo-fence based on variable identifiers of one or more wireless signal generators in an electronic device.

In accordance with an aspect of the present disclosure, a mobile electronic device is provided. The mobile electronic device includes an electronic device housing; a non-cellular communication module contained in the electronic device housing; a battery contained in the electronic device housing; a processor contained in the electronic device housing and electrically connected to the non-cellular communication module; a user interface operatively connected to the processor; and a memory electrically connected to the processor, wherein the memory stores instructions that, when executed, cause the processor to receive a first variable identifier and a first unique identifier from a first wireless signal generator in a geographical area including a plurality of wireless signal generators through the communication module, provide the first variable identifier through the user interface, associate the first variable identifier with a first point of interest and storing the association in the memory, receive a second variable identifier and a second unique identifier from a second wireless signal generator among the plurality of wireless signal generators through the communication module, and automatically associate the second variable identifier with the first point of interest, based on whether or not the second variable identifier is the same, at least in part, as the first variable identifier, and store the association in the memory.

In accordance with another aspect of the present disclosure, a method of a mobile electronic device is provided. The method includes receiving a first variable identifier and a first unique identifier from a first wireless signal generator in a geographical area containing a plurality of wireless signal generators; providing the first variable identifier through a user interface of the mobile electronic device; associating the first variable identifier with a first point of interest and storing the association; receiving a second variable identifier and a second unique identifier from a second wireless signal generator among the plurality of wireless signal generators; and automatically associating the second variable identifier with the first point of interest, based on whether or not the second variable identifier is the same, at least in part, as the first variable identifier, and storing the association.

### BRIEF DESCRIPTION OF THE DRAWINGS

The above and other aspects, features, and advantages of the present disclosure will be more apparent from the following detailed description, taken in conjunction with the accompanying drawings, in which:

FIG. 1 is a block diagram of an electronic device in a network environment, according to an embodiment of the present disclosure;

FIG. 2 is a block diagram of an electronic device, according to an embodiment of the present disclosure;

FIG. 3 is a block diagram of a program module, according to an embodiment of the present disclosure;

FIG. 4 illustrates a method of configuring a geo-fence in a program module, according to an embodiment of the present disclosure;

FIG. 5 is a block diagram of an electronic device for configuring a geo-fence, according to an embodiment of the present disclosure;

FIG. 6 is a flowchart of a method of configuring a geo-fence in an electronic device, according to an embodiment of the present disclosure;

FIG. 7A to FIG. 7D are illustrations of a screen configuration for configuring a geo-fence, according to an embodiment of the present disclosure;

FIG. 8 is a flowchart of a method of registering a first wireless signal generator in a geo-fence in an electronic device, according to an embodiment of the present disclosure;

FIG. 9 illustrates a network structure for configuring and extending a geo-fence, according to an embodiment of the present disclosure;

FIG. 10 is a flowchart of a method of extending a range of a geo-fence based on a signal strength of a wireless signal generator in an electronic device, according to an embodiment of the present disclosure;

FIG. 11 is a flowchart of a method of extending a range of a geo-fence based on a cell containing a wireless signal generator in an electronic device, according to an embodiment of the present disclosure;

FIG. 12 is a flowchart of a method of integrating geo-fences in an electronic device, according to an embodiment of the present disclosure;

FIG. 13A and FIG. 13B are illustrations of a screen configuration for integrating geo-fences in an electronic device, according to an embodiment of the present disclosure;

FIG. 14 is a flowchart of a method of configuring and extending a geo-fence based on a wireless signal generator name in an electronic device, according to an embodiment of the present disclosure;

FIG. 15 is a flowchart of a method of determining a location based on a geo-fence in an electronic device, according to an embodiment of the present disclosure;

FIG. 16 is an illustration of a network structure for determining entry into a geo-fence, according to an embodiment of the present disclosure; and

FIG. 17A to FIG. 17C are illustrations of a screen configuration for selecting a geo-fence in an electronic device, according to an embodiment of the present disclosure.

### DETAILED DESCRIPTION OF EMBODIMENTS OF THE PRESENT DISCLOSURE

Hereinafter, various embodiments of the present disclosure are described below with reference to the accompanying drawings. In the following description, certain details such as a detailed configuration and components are merely provided to assist in the overall understanding of embodiments of the present disclosure. Therefore, it should be apparent to those skilled in the art that various changes and modifications of the embodiments described herein may be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure is described in detail below with reference to the accompanying drawings. However, it should be understood that the present disclosure is not intended to be limited to the embodiments, but includes all modifications/changes, equivalents, and/or alternatives falling within the spirit and the scope of the present disclosure as defined by the appended claims and their equivalents. In describing the accompanying drawings, similar reference numerals may be used to designate similar elements.

The terms “have,” “may have,” “include,” or “may include” used in the present disclosure indicate the presence of disclosed corresponding functions, operations, elements, and the like, but do not limit additional one or more functions, operations, elements, and the like. In addition, it should be understood that the terms “include” and “have” used in the present disclosure indicate the presence of features, numbers, steps, operations, elements, parts, or a combination thereof described in the present disclosure, but do not preclude the presence or addition of one or more other features, numbers, steps, operations, elements, parts, or a combination thereof.

The terms “A or B,” “at least one of A and/or B” or “one or more of A and/or B” used in the present disclosure include all combinations of words enumerated therewith. For example, “A or B,” “at least one of A and B” or “at least one of A or B” indicates (1) including at least one A, (2) including at least one B, or (3) including both at least one A and at least one B.

Although the terms such as “first” and “second” used in the present disclosure may modify various elements of various embodiments, these terms are not intended to limit the corresponding elements. For example, these terms are not intended to limit an order and/or the importance of the corresponding elements. These terms may be used for the purpose of distinguishing one element from another element. For example, a first user device and a second user device indicate user devices and may indicate different user devices. For example, a first element may be referred to as a second element without departing from the scope and spirit of the present disclosure, and similarly, a second element may be referred to as a first element.

It should be understood that when an element (e.g., a first element) is “connected to” or “(operatively or communicatively) coupled with/to” another element (e.g., a second element), the element may be directly connected or coupled to another element, or there may be an intervening element (e.g., a third element) between the element and the other element. In contrast, it should be understood that when an element (e.g., the first element) is “directly connected” or “directly coupled” to another element (e.g., the second element), there is no intervening element (e.g., the third element) between the element and the other element.

The expression “configured (or set) to” used in the present disclosure may be used interchangeably with “suitable for,”, “having the capacity to,” “designed to,” “adapted to,” “made to,” or “capable of” according to the situation. The term “configured (or set) to” does not necessarily indicate “specifically designed to” in hardware. Instead, “configured to . . . ” may indicate “capable of . . . ” along with other devices or parts in a certain situation. For example, “a processor configured (or set) to perform A, B, and C” may be a dedicated processor, e.g., an embedded processor, for performing a corresponding operation, or a general purpose processor, e.g., a central processing unit (CPU) or an application processor, capable of performing a corresponding operation by executing one or more software programs stored in a memory device.

The terms as used herein are used merely to describe certain embodiments of the present disclosure but are not intended to limit the present disclosure. As used herein, singular forms may include plural forms, unless the context explicitly indicates otherwise. Further, all the terms used herein, should be interpreted to have the same meanings as commonly understood by those skilled in the art to which the present disclosure pertains, and should not be interpreted to have ideal or excessively formal meanings unless explicitly defined in the present disclosure.

An electronic device according to an embodiment of the present disclosure may be a device. For example, the electronic device according to an embodiment of the present disclosure may include at least one of a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); a moving picture experts group audio layer 3 (MP3) player; a mobile medical device; a camera; a bank of power sources; or a wearable device (e.g., a head-mounted-device (HMD), electronic glasses, electronic clothing, an electronic bracelet, an electronic necklace, an electronic appcessory, an electronic tattoo, a smart mirror, or a smart watch).

In an embodiment of the present disclosure, an electronic device may be a home appliance. For example, a home appliance may include at least one of a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync, Apple TV®, or Google TV); a game console (e.g., Xbox® PlayStation®); an electronic dictionary; an electronic key; a camcorder; or an electronic frame.

In an embodiment of the present disclosure, an electronic device may include at least one of a medical equipment (e.g., a mobile medical device (e.g., a blood glucose monitoring device, a heart rate monitor, a blood pressure monitoring device or a thermometer), a magnetic resonance angiography (MRA) machine, a magnetic resonance imaging (MRI) machine, a computed tomography (CT) scanner, or an ultrasound machine); a navigation device; a global navigation satellite system (GNSS); an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for a vehicle; an industrial or home robot; an automated teller machine (ATM) of a financial institution, a point of sale (POS) device at a retail store, or an Internet of Things device (e.g., a light bulb, various sensors, an electronic meter, a gas meter, a sprinkler, a fire alarm, a thermostat, a streetlamp, a toaster, sports equipment, a hot-water tank, a heater, a boiler, and the like).

In an embodiment of the present disclosure, an electronic device may include at least one of a piece of furniture or a building/structure; an electronic board; an electronic signature receiving device; a projector; and various measuring instruments (e.g., a water meter, an electricity meter, a gas meter, or a wave meter). Further, it will be apparent to those skilled in the art that an electronic device according to an embodiment of the present disclosure is not limited to the above-mentioned devices.

Herein, the term “user” may indicate a person who uses an electronic device or a device (e.g., an artificial intelligence electronic device) that uses an electronic device.

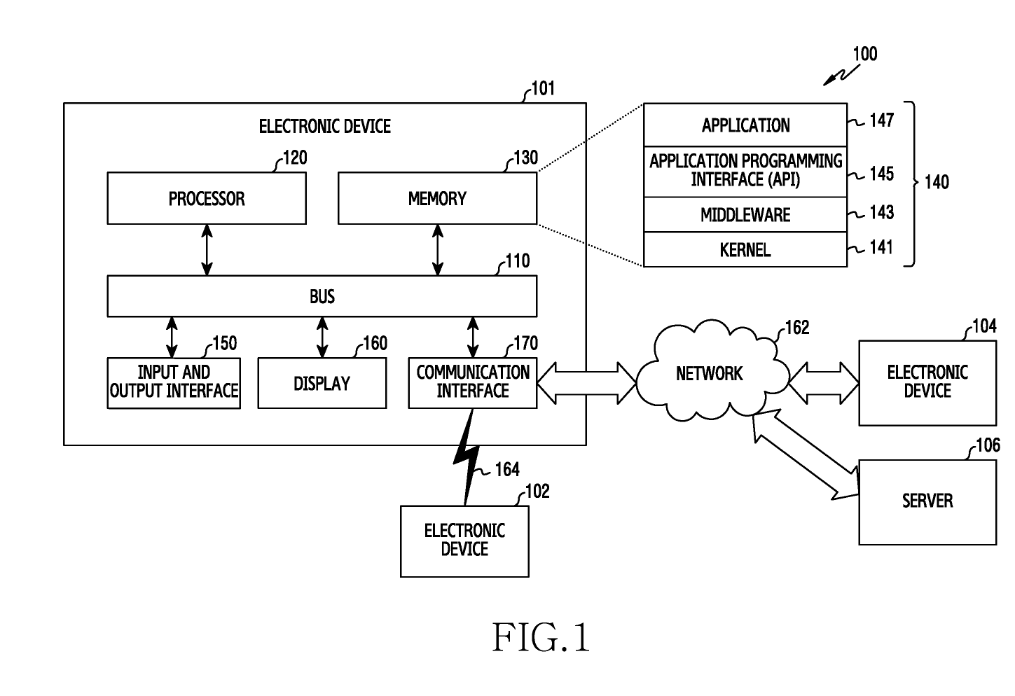

FIG. 1 is a block diagram of an electronic device 101 in a network environment 100, according to an embodiment of the present disclosure.

Referring to FIG. 1, the electronic device 101 may include a bus 110, a processor 120, a memory 130, an input/output interface 150, a display 160, and a communication interface 170. In an embodiment of the present disclosure, at least one of the elements 110 to 170 of the electronic device 101 may be omitted, or other elements may be additionally included in the electronic device 101.

The bus 110 may include, for example, a circuit that interconnects the elements 110 to 170 and transfers communication (e.g., a control message and/or data) between the elements 110 to 170.

The processor 120 may include one or more of a CPU, an application processor, and a communication processor (CP). The processor 120 may, for example, perform an operation or process data on control and/or communication of at least one other element of the electronic device 101.

The memory 130 may include a volatile memory and/or a non-volatile memory. The memory 130 may store, for example, instructions or data (e.g. pre-stored location information, location information matched with a network) relevant to at least one other element of the electronic device 101. According to an embodiment of the present disclosure, the memory 130 may store software and/or a program 140. For example, the program may include a kernel 141, middleware 143, an application programming interface (API) 145, and at least one application (or “application program”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented by the other programs (e.g., the middleware 143, the API 145, or the application 147). Furthermore, the kernel 141 may provide an interface through which the middleware 143, the API 145, or the application 147 may access the individual elements of the electronic device 101 to control or manage the system resources.

The middleware 143, for example, may function as an intermediary for allowing the API 145 or the application 147 to communicate with the kernel 141 to exchange data.

In addition, the middleware 143 may process one or more task requests received from the application 147 according to priorities thereof. For example, the middleware 143 may assign priorities for using the system resources (e.g., the bus 110, the processor 120, the memory 130, or the like) of the electronic device 101 to at least one of the applications 147. For example, the middleware 143 may perform scheduling or load balancing on the one or more task requests by processing the one or more task requests according to priorities assigned thereto.

The API 145 is an interface through which the application 147 controls functions provided by the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 101. Furthermore, the input/output interface 150 may output the instructions or data received from the other element(s) of the electronic device 101 to a user or another external device.

Examples of the display 160 may include a liquid crystal display (LCD), a light-emitting diode (LED) display, an organic light emitting diode (OLED) display, a microelectromechanical systems (MEMS) display, and an electronic paper display. The display 160, for example, may display various types of content (e.g., text, images, videos, icons, or symbols) to a user. The display 160 may include a touch screen and receive, for example, a touch, gesture, proximity, or hovering input using an electronic pen or a part of a user's body.

The communication interface 170, for example, may establish communication between the electronic device 101 and an external device (e.g., a first external electronic device 102, a second external electronic device 104, or a server 106). For example, the communication interface 170 may be connected to a network 162 through wireless or wired communication to communicate with the second external electronic device 104 or the server 106.

The wireless communication may use at least one of, for example, long term evolution (LTE), LTE advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may be performed by using at least one of, for example, WiFi, Bluetooth, Bluetooth low energy (BLE), near field communication (NFC), and GNSS. The GNSS may include at least one of, for example, a global positioning system (GPS), a global navigation satellite system (Glonass), a Beidou navigation satellite system (hereinafter, referred to as “Beidou”), and European global satellite-based navigation system (Galileo). Hereinafter, in the present disclosure, “GPS” may be interchangeably used with “GNSS.” The wired communication may include at least one of, for example, a universal serial bus (USB), a high definition multimedia interface (HDMI), recommended standard 232 (RS-232), and a plain old telephone service (POTS). The network 162 may include at least one of a communication network such as a computer network (e.g., a local area network (LAN) or a wide area network (WAN)), the Internet, and a telephone network.

Each of the first and second external electronic devices 102 and 104 may be of a type identical to or different from that of the electronic device 101. According to an embodiment of the present disclosure, the server 106 may include a group of one or more servers. According to an embodiment of the present disclosure, all or some of the operations performed in the electronic device 101 may be performed in another electronic device or a plurality of electronic devices 102, 104, or the server 106. According to an embodiment of the present disclosure, when the electronic device 101 must perform some functions or services automatically or in response to a request, the electronic device 101 may request the electronic device 102, 104, or the server 106 to perform at least some functions relating thereto instead of or in addition to performing the functions or services itself. The electronic device 102,104, or the server 106 may execute the requested functions or the additional functions, and may provide the result to the electronic device 101. The electronic device 101 may process the received result as is or further process the result in order to provide the requested functions or services. To achieve this, for example, cloud computing, distributed computing, or client-server computing technology may be used.

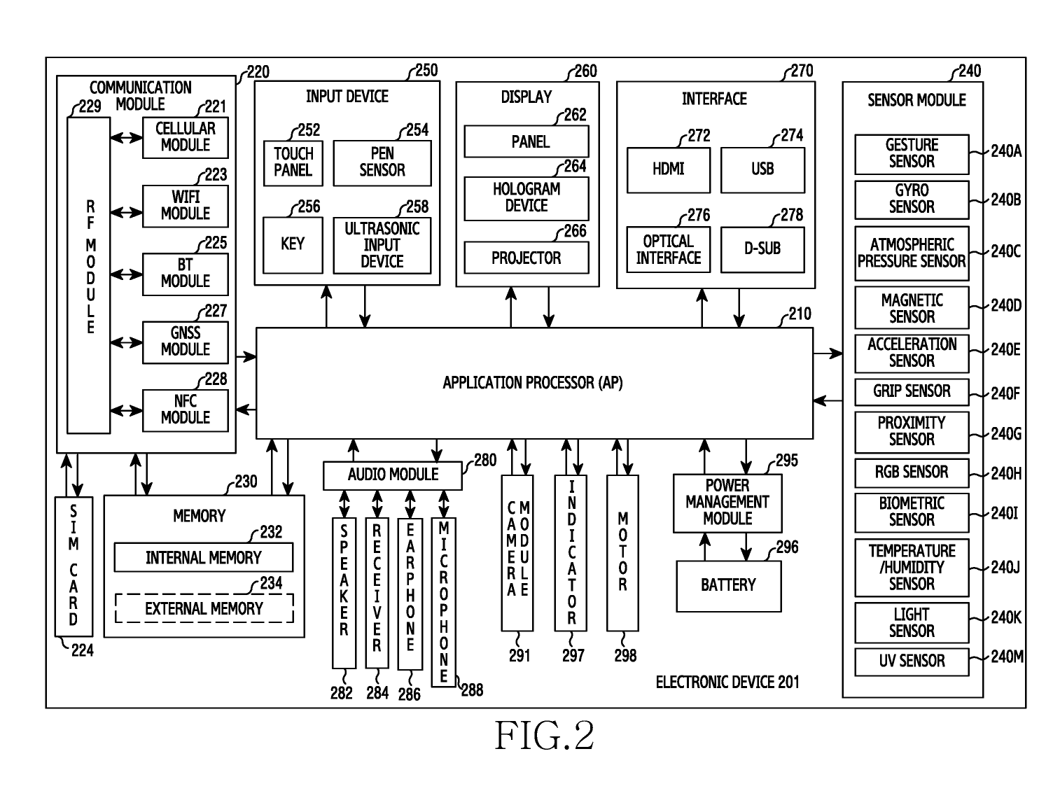

FIG. 2 is a block diagram of an electronic device 201 according to an embodiment of the present disclosure. The electronic device 201 may include, for example, all or a part of the electronic device 101 illustrated in FIG. 1. The electronic device 201 may include at least one application processor 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The application processor 210 may, for example, control a plurality of hardware or software elements connected thereto and perform a variety of data processing and calculations by functioning an operating system or an application program. The application processor 210 may be implemented as, for example, a system on chip (SoC). According to an embodiment of the present disclosure, the application processor 210 may further include a graphics processing unit (GPU) and/or an image signal processor. The application processor 210 may include at least some of the elements (e.g., a cellular module 221) illustrated in FIG. 2. The application processor 210 may load commands or data, received from at least one other element (e.g., a non-volatile memory), into a volatile memory to process the loaded commands or data, and may store various types of data in the non-volatile memory.

The communication module 220 may have a configuration that is the same as or similar to that of the communication interface 170 of FIG. 1. The communication module 220 may include, for example, the cellular module 221, a WiFi module 223, a BT module 225, a GNSS module 227, an NFC module 228, and a radio frequency (RF) module 229. The communication module 220 provides a function of transmitting/receiving a signal. Accordingly, the communication module 220 may be referred to as a “reception unit,” a “transmission unit,” a “transmission and reception unit,” a “communication unit,” or the like.

The cellular module 221 may provide, for example, a voice call, a video call, a text message service, or an Internet service through a communication network. According to an embodiment of the present disclosure, the cellular module 221 may distinguish and authenticate the electronic device 201 in the communication network by using the SIM card 224. According to an embodiment of the present disclosure, the cellular module 221 may perform at least some of the functions that the application processor 210 may provide. According to an embodiment of the present disclosure, the cellular module 221 may include a CP.

The WiFi module 223, the BT module 225, the GNSS module 227, or the NFC module 228 may include, for example, a processor for processing data transmitted/received through the corresponding module. According to an embodiment of the present disclosure, at least some (e.g., two or more) of the cellular module 221, the WiFi module 223, the BT module 225, the GNSS module 227, and the NFC module 228 may be included in a single integrated circuit or chip (IC) or IC package.

The RF module 229 may, for example, transmit/receive a communication signal (e.g., an RF signal). The RF module 229 may include, for example, a transceiver, a power amplifier module (PAM), a frequency filter, a low noise amplifier (LNA), or an antenna. According to another embodiment of the present disclosure, at least one of the cellular module 221, the WiFi module 223, the BT module 225, the GNSS module 227, and the NFC module 228 may transmit/receive an RF signal through a separate RF module.

The SIM card 224 may include, for example, an embedded SIM, and may further include unique identification information (e.g., an integrated circuit card identifier (ICCID)) or subscriber information (e.g., international mobile subscriber identity (IMSI)).

The memory 230 may include, for example, an internal memory 232 or an external memory 234. The internal memory 232 may include, for example, at least one of a volatile memory (e.g., a dynamic random access memory (DRAM), a static RAM (SRAM), a synchronous dynamic RAM (SDRAM), or the like) and a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, or a solid state drive (SSD)).

The external memory 234 may further include a flash drive, for example, a compact flash (CF), a secure digital (SD), a micro secure digital (Micro-SD), a mini secure digital (Mini-SD), an extreme digital (xD), a memory stick, or the like. The external memory 234 may be functionally and/or physically connected to the electronic device 201 through various interfaces.

The sensor module 240 may measure, for example, a physical quantity or detect an operational status of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a Red, Green, Blue (RGB) sensor), a biometric sensor 240I, a temperature/humidity sensor 240J, a light sensor 240K, and an ultra violet (UV) light sensor 240M. Additionally or alternatively, the sensor module 240 may include, for example, an electronic nose (E-nose) sensor, an electromyography (EMG) sensor, an electroencephalogram (EEG) sensor, an electrocardiogram (ECG) sensor, an infrared (IR) sensor, an iris sensor, a force touch sensor, and/or a fingerprint sensor. The sensor module 240 may further include a control circuit for controlling at least one sensors included therein. In an embodiment of the present disclosure, the electronic device 201 may further include a processor configured to control the sensor module 240 either separately or as a part of the processor 210, and may control the sensor module 240 while the processor 210 is in a reduced power consumption mode (e.g. a sleep state).

The input device 250 may include, for example, a touch panel 252, a (digital) pen sensor 254, a key 256, or an ultrasonic input device 258. The touch panel 252 may use at least one of, for example, a capacitive type panel, a resistive type panel, an infrared type panel, and an ultrasonic type panel. In addition, the touch panel 252 may further include a control circuit. The touch panel 252 may further include a tactile layer to provide a tactile reaction to a user.

The (digital) pen sensor 254 may be, for example, a part of the touch panel 252, or may include a separate recognition sheet. The key 256 may include, for example, a physical button, an optical key, or a keypad. The ultrasonic input device 258 may identify data by detecting acoustic waves with a microphone 288 of the electronic device 201 through an input unit for generating an ultrasonic signal.

The display 260 (e.g., the display 160 of FIG. 1) may include a panel 262, a hologram device 264, or a projector 266. The panel 262 may include a configuration that is the same as or similar to that of the display 160 of FIG. 1. The panel 262 may be implemented to be, for example, flexible, transparent, or wearable. The panel 262 may be configured as a single module integrated with the touch panel 252. The hologram device 264 may project a stereoscopic image in the air using the interference of light. The projector 266 may project light onto a screen to display an image. The screen may be located, for example, in the interior of or exterior to the electronic device 201. According to an embodiment of the present disclosure, the display 260 may further include a control circuit for controlling the panel 262, the hologram device 264, or the projector 266.

The interface 270 may include, for example, a high-definition multimedia interface (HDMI) 272, a USB 274, an optical interface 276, or a D-subminiature (D-sub) connector 278. The interface 270 may be included in, for example, the communication interface 160 illustrated in FIG. 1. Additionally or alternatively, the interface 270 may include, for example, a mobile high-definition link (MHL) interface, an SD card/multi-media card (MMC) interface, or an Infrared Data Association (IrDA) standard interface.

The audio module 280 may, for example, convert a sound into an electrical signal, and vice versa. At least some elements of the audio module 280 may be included in, for example, the input/output interface 150 illustrated in FIG. 1. The audio module 280 may, for example, process sound information that is input or output through a speaker 282, a receiver 284, an earphone 286, the microphone 288, or the like.

The camera module 291 may be, for example, a device that can take a still image or a moving image, and according to an embodiment of the present disclosure, the camera module 291 may include one or more image sensors (e.g., a front sensor or a rear sensor), a lens, an image signal processor (ISP), or a flash (e.g., an LED or a xenon lamp).

The power management module 295 may, for example, manage power of the electronic device 201. According to an embodiment of the present disclosure, the power management module 295 may include a power management integrated circuit (PMIC), a charger IC, or a battery gauge. The PMIC may use a wired and/or a wireless charging method. Examples of a wireless charging method may include, for example, a magnetic resonance scheme, a magnetic induction scheme, an electromagnetic wave scheme, and the like. Further, the power management module 295 may further include additional circuits (e.g., a coil loop, a resonance circuit, a rectifier, etc.) for wireless charging. The battery gauge may measure, for example, a residual quantity of the battery 296, and a voltage, a current, or a temperature during charging. The battery 296 may include, for example, a rechargeable battery and/or a solar battery.

The indicator 297 may indicate a certain state of the electronic device 201 or a part thereof (e.g., the application processor 210), for example, a booting state, a message state, a charging state, or the like. The motor 298 may convert an electrical signal into a mechanical vibration, and may generate a vibration or a haptic effect. The electronic device 201 may include a processing unit (e.g., a GPU) for mobile TV support. The processing device for mobile TV support may, for example, process media data according to a standard of digital multimedia broadcasting (DMB), digital video broadcasting (DVB), media flow, or the like.

Each of the components of the electronic device 201 according to an embodiment of the present disclosure may be implemented by one or more components, where the name of the corresponding component may vary depending on a type of the electronic device 201. In an embodiment of the present disclosure, the electronic device 201 may include at least one of the above-described elements. Some of the above-described elements may be omitted from the electronic device 201, or the electronic device 201 may further include additional elements. Further, some of the elements of the electronic device 201 according to an embodiment of the present disclosure may be coupled to form a single entity while performing the same functions as those of the corresponding elements before coupling.

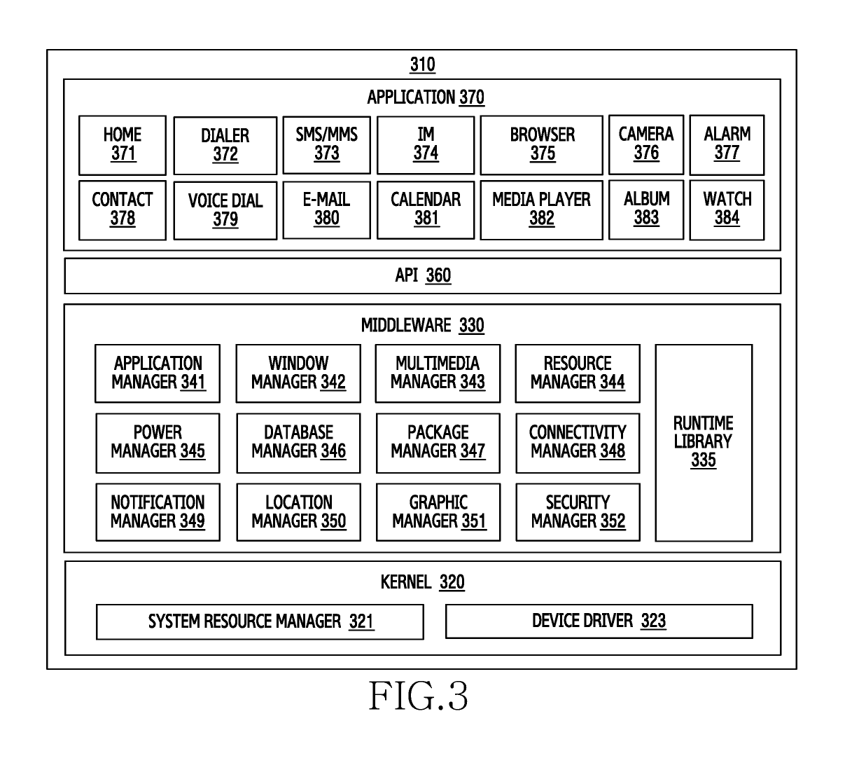

FIG. 3 is a block diagram of a program module 310 according to an embodiment of the present disclosure. According to an embodiment of the present disclosure, the program module 310 (e.g., the program 140 of FIG. 1) may include an OS that controls resources relating to the electronic device 101 and/or various applications (e.g., the application 147) executed in the OS. The OS may be, for example, Android, iOS™, Windows®, Symbian™, Tizen®, Bada™, or the like.

The programming module 310 may include a kernel 320, middleware 330, an application programming interface (API) 360, and/or an application 370. At least some of the program module 310 may be preloaded in the electronic device 101, or may be downloaded from a external electronic device (e.g., the electronic devices 102, 104, or the server 106).

The kernel 320 (e.g., the kernel 141 of FIG. 1) may include, for example, a system resource manager 321 or a device driver 323. The system resource manager 321 may control, allocate, or collect system resources. According to an embodiment of the present disclosure, the system resource manager 321 may include a process management unit, a memory management unit, or a file system management unit. The device driver 323 may include, for example, a display driver, a camera driver, a Bluetooth driver, a shared-memory driver, a USB driver, a keypad driver, a WiFi driver, an audio driver, or an inter-process communication (IPC) driver.

The middleware 330 may provide a function required in common by the application 370, or may provide various functions to the application 370 through the API 360 to enable the application 370 to efficiently use limited system resources in the electronic device 101. According to an embodiment of the present disclosure, the middleware 330 (e.g., the middleware 143 of FIG. 1) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module used by a complier in order to add a new function through a programming language during execution of the application 370. The runtime library 335 may perform input/output management, memory management, or a function for an arithmetic function.

The application manager 341 may manage, for example, a life cycle of at least one application of the application 370. The window manager 342 may manage GUI resources used by a screen. The multimedia manager 343 may identify a format required for reproducing various media files, and may encode or decode a media file using a codec suitable for the corresponding format. The resource manager 344 may manage resources of at least one of application of the application 370, such as source code, memory, storage space, and the like.

The power manager 345 may operate together with, for example, a basic input/output system (BIOS) to manage a battery or power consumption and provide power consumption information required for an operation of the electronic device 101. The database manager 346 may generate, search, or change a database to be used by at least one application of the application 370. The package manager 347 may manage installation or update of an application distributed in the format of a package file.

The connectivity manager 348 may manage, for example, a wireless connection, such as WiFi or Bluetooth. The notification manager 349 may display or notify of an event, such as a received message, an appointment, and a proximity notification, in such a manner as not to disturb a user. The location manager 350 may manage location information of the electronic device 101. The graphic manager 351 may manage a graphic effect to be provided to a user, or a user interface related thereto. The security manager 352 may provide all security functions required for system security or user authentication. According to an embodiment of the present disclosure, in cases where the electronic device 101 includes a telephone call function, the middleware 330 may further include a telephony manager for managing a voice or video call function of the electronic device 101. Also, the middleware 330 may further include a geo-fence manager for setting and managing a geo-fence.

The middleware 330 may include a middleware module that forms combinations of various functions of the aforementioned elements. The middleware 330 may provide modules according to the types of OSs in order to provide differentiated functions. In addition, the middleware 330 may dynamically delete some of the existing elements, or may add new elements.

The API 360 (e.g., the API 145 of FIG. 1) may be, for example, a set of API programming functions, and may be provided with different configurations according to the type of OS. For example, in the case of Android® or iOS®, one API set may be provided for each platform, and in the case of Tizen®, two or more API sets may be provided for each platform.

The application 370 (e.g., the application 147 of FIG. 1) may include, for example, one or more applications that can provide functions, such as a home application 371, a dialer application 372, a short message service/multimedia messaging service (SMS/MMS) application 373, an instant message (IM) application 374, a browser application 375, a camera application 376, an alarm application 377, a contact application 378, a voice dialer application 379, an e-mail application 380, a calendar application 381, a media player application 382, an album application 383, a clock application 384, a health care application (e.g., to measure a quantity of exercise or a blood sugar level), or environmental information (e.g., atmospheric pressure, humidity, or temperature information).

According to an embodiment of the present disclosure, the application 370 may include an application (“information exchange application”) that supports information exchange between the electronic device 101 and external electronic devices 102 and 104. The information exchange application may include, for example, a notification relay application for transmitting information to an external electronic device 102 or 104, or a device management application for managing the external electronic device 102 or 104.

For example, the notification relay application may include a function of transferring, to an external electronic device 102 or 104, notification information generated from other applications of the electronic device 101 (e.g., an SMS/MMS application 373, an e-mail application 380, a health management application, or an environmental information application). Furthermore, the notification relay application may, for example, receive notification information from an external electronic device 102 or 104 and provide the received notification information to a user. The device management application may, for example, manage (e.g., install, delete, or update) at least one function of an external electronic device 102 or 104 communicating with the electronic device 101 (for example, a function of turning on/off the external electronic device 101 (or some elements thereof), or a function of adjusting luminance (or resolution) of a display), applications operating in the external electronic device 102 or 104, or services provided by the external electronic device 102 or 104 (e.g., a telephone call service or a message service).

According to an embodiment of the present disclosure, the application 370 may include an application (e.g., a health care application) specified according to attributes (e.g., attributes of the electronic device 101 such as the type of electronic device 101 which corresponds to a mobile medical device) of the external electronic device 102 or 104. According to an embodiment of the present disclosure, the application 370 may include an application received from the server 106 or the electronic device 102 or 104. According to an embodiment of the present disclosure, the application 370 may include a preloaded application or a third party application that can be downloaded from a server. The names of the elements of the program module 310, according to an embodiment of the present disclosure, may vary according to the type of OS.

According to an embodiment of the present disclosure, the application 370 may include at least one application related to setting a geo-fence.

According to an embodiment of the present disclosure, at least a part of the programming module 310 may be implemented in software, firmware, hardware, or a combination of two or more thereof. At least some of the programming module 310 may be implemented (for example, executed) by, for example, the application processor 210. At least some of the programming module 310 may include, for example, a module, a program, a routine, sets of instructions, a process, or the like for performing one or more functions.

In an embodiment of the disclosure, the geo-fence may represent a point of interest.

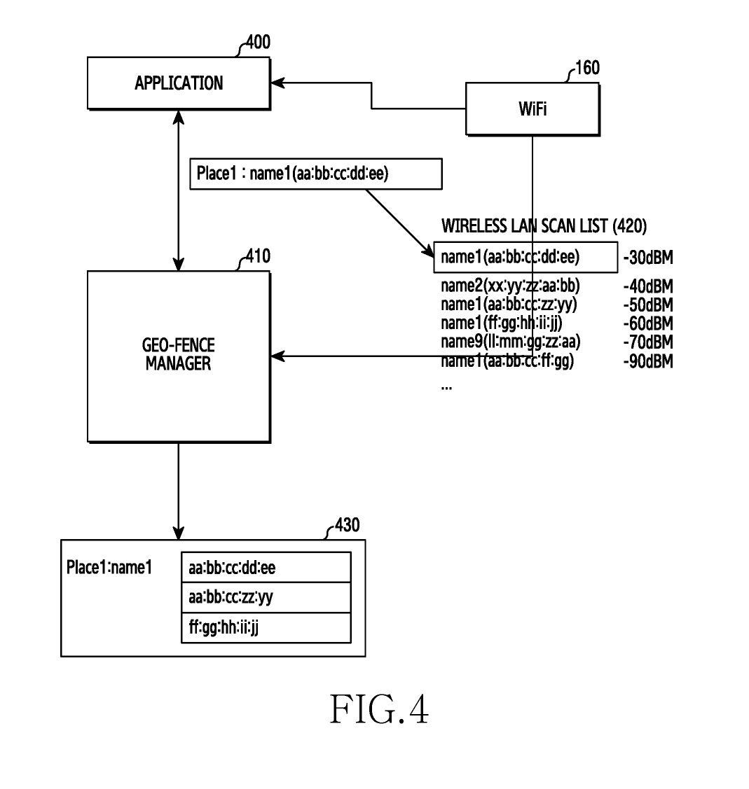

FIG. 4 illustrates a method of configuring a geo-fence in a program module, according to an embodiment of the present disclosure.

Referring to FIG. 4, when an event for configuring a geo-fence occurs, a geo-fence application 400 of the application 370 may provide information on one or more wireless signal generators to a geo-fence manager 410 that is contained in the middleware 330. For example, the geo-fence application 400 may select a first wireless signal generator (e.g., an access point) to be connected from a wireless scan list 420 that is obtained through a WiFi module 223. The geo-fence application 400 may transmit information {e.g., a variable identifier (service set identifier (SSID)) and a unique identifier (basic variable identifier (BSSID))} on the first wireless signal generator to the geo-fence manager 410. For example, the geo-fence application 400 may transmit, to the geo-fence manager 410, the information on the first wireless signal generator that is connected at the time when the event for configuring the geo-fence occurs. In this case, the wireless signal generator may include an access point or a beacon generator. For example, the access point may operate based on the wireless LAN (e.g. WiFi) protocol, and the beacon generator may operate based on the Bluetooth protocol.

According to an embodiment of the present disclosure, the geo-fence manager 410 may register information on a first wireless signal generator, which is received from the geo-fence application 400 in response to an occurrence of an event for the configuration of a geo-fence, in a first geo-fence (for example, a first point of interest or Place 1). For example, the geo-fence manager 410 may store the information on the first wireless signal generator, which is received from the geo-fence application 400, to correspond to the first geo-fence (for example, the first point of interest or Place 1).

According to an embodiment of the present disclosure, the geo-fence manager 410 may extend a first geo-fence (for example, a first point of interest or Place 1) based on a variable identifier (e.g., a name (for example, Name 1) of a first wireless signal generator. For example, the geo-fence manager 410 may register, in the first geo-fence (for example, the first point of interest or Place 1), information on a second wireless signal generator, of which the name is the same, at least in part, as the name of the first wireless signal generator, from the wireless LAN scan list 420 that is obtained through a wireless LAN module. That is, the geo-fence manager 410 may add identification information of the second wireless signal generator to a geo-fence table 430 that is stored in one or more memories 130 or 230 and/or in one or more servers 106. Then, the geo-fence manager 410 may register, in the first geo-fence (for example, the first point of interest or Place 1), information on the second wireless signal generator that has a greater signal strength than the reference signal strength (e.g., −84 dBm) among the second wireless signal generators. For example, the geo-fence manager 410 may configure, as the first geo-fence (for example, the first point of interest or Place 1), the second wireless signal generators that have the unique identifiers (e.g., a MAC address) of “aa:bb:cc:zz:yy” and “ff:gg:hh:ii:jj,” which have a greater wireless signal strength than the reference signal strength among the second wireless signal generators (e.g., “aa:bb:cc:zz:yy,” “ff:gg:hh:ii:jj,” and “aa:bb:cc:ff:gg”), of which the names are the same, at least in part, as the name of the first wireless signal generator. Additionally, the geo-fence manager 410 may selectively register the second wireless signal generator in the first geo-fence (for example, the first point of interest or Place 1), based on information on a cell that contains the second wireless signal generator.

According to an embodiment of the present disclosure, the geo-fence manager 410 may extend the geo-fence based on the wireless LAN scan list 420 that is periodically detected in the geo-fence.

According to an embodiment of the present disclosure, when the location manager 350 is connected to the second wireless signal generator (e.g., aa:bb:cc:zz:yy) that is registered in the table 430 of the first geo-fence (for example, the first point of interest or Place 1), it may be determined that the electronic device 101 is located in the first geo-fence (for example, the first point of interest or Place 1). The location manager 350 may provide entry information into the geo-fence to the geo-fence application 400.

According to an embodiment of the present disclosure, if the location manager 350 is disconnected from the second wireless signal generator in response to the movement of the electronic device 101, but is connected to the first wireless signal generator (e.g., aa:bb:cc:dd:ee), it may be determined that the electronic device 101 is located in the geo-fence.

According to an embodiment of the present disclosure, the electronic device 101 may store a table for storing configuration information on the geo-fence and a table for storing extension information on the corresponding geo-fence to be separated from each other. For example, in the case of FIG. 4, the electronic device 101 may store, in the first table, the information on the first wireless signal generator that is selected by the geo-fence application 400 from the wireless LAN scan list 420. The first table may store the geo-fence name, and the name and identification information of the first wireless signal generator. When the electronic device 101 adds the second wireless signal generator to the geo-fence, the electronic device 101 may store the identification information of the second wireless signal generator in the second table for the geo-fence of the first wireless signal generator. The second table may store the geo-fence name and the identification information of the wireless signal generator.

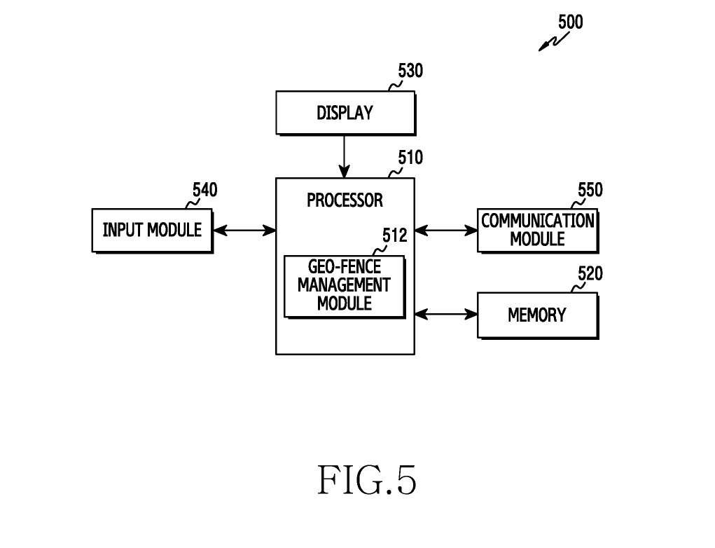

FIG. 5 is a block diagram of an electronic device 500 for configuring a geo-fence, according an embodiment of the present disclosure.

Referring to FIG. 5, the electronic device 500 (e.g., the electronic device 101 of FIG. 1 or the electronic device 201 of FIG. 2) may include a processor 510, a memory 520, a display 530, an input module 540, and a communication module 550.

The processor 510 (e.g., the processor 120 of FIG. 1) may include at least one of a CPU, an application processor, or a CP.

The processor 510 may include at least one geo-fence management module 512. The processor 510 may configure a geo-fence by using the geo-fence management module 512. For example, when an occurrence of an event for configuring a geo-fence is detected, the geo-fence management module 512 may select a first wireless signal generator {e.g., an access point (AP)} from a network scan list (e.g., a wireless LAN scan list 420 in FIG. 4) and may configure the same as the geo-fence. Then, the geo-fence management module 512 may control the communication module 550 to be connected to (e.g. to access) the first wireless signal generator. For example, the geo-fence management module 512 may configure, as the geo-fence, the first wireless signal generator that is connected at the time when the event for the configuration of the geo-fence occurs.

According to an embodiment of the present disclosure, when a geo-fence is configured, the geo-fence management module 512 may associate one or more application programs, one or more functions, or one or more mode changes with the geo-fence.

According to an embodiment of the present disclosure, the geo-fence management module 512 may extend a geo-fence, based on a variable identifier (e.g., a name) of a first wireless signal generator. For example, the geo-fence management module 512 may register, in the geo-fence, a second wireless signal generator (for example, another AP), of which the variable identifier is the same, at least in part, as the variable identifier of the first wireless signal generator (e.g., the AP), among the network scan list (e.g., the wireless LAN scan list 420 of FIG. 4) that is obtained in the geo-fence. Then, the geo-fence management module 512 may register, in the geo-fence, the second wireless signal generator that has a greater signal strength than the reference signal strength (for example, −83 dBm) among the second wireless signal generators that have the same or similar variable identifiers as the first wireless signal generator. Additionally, the processor 510 may add the second wireless signal generator, which belongs to the same cell as the first wireless signal generator or belongs to a nearby cell, to the geo-fence. In this case, the variable identifier may represent the identification information that can be changed based on input information, such as the name of the wireless signal generator {e.g., the SSID of the AP} or the service name of the beacon generator (e.g., trade names, building names, local names, or changeable names by the user's configuration), which is detected through the input module 540.

According to an embodiment of the present disclosure, in the case where a wireless signal generator to be registered in a geo-fence is registered in another geo-fence, the geo-fence management module 512 may integrate the geo-fences. For example, in the case where the wireless signal generator to be registered in the geo-fence is registered in another geo-fence, the geo-fence management module 512 may control the display 530 to display a geo-fence selection screen. The geo-fence management module 512 may integrate the geo-fences that are duplicated with respect to a single wireless signal generator into a single geo-fence based on the input information corresponding to the geo-fence selection screen.

According to an embodiment of the present disclosure, the geo-fence management module 512 may determine the location of the electronic device 500 based on the registration information of the geo-fence. For example, when the geo-fence management module 512 is connected to a wireless signal generator, the geo-fence management module may identify the unique identifier of the wireless signal generator. If the unique identifier of the wireless signal generator is a registered unique identifier in the geo-fence, the geo-fence management module 512 may determine that the electronic device 500 has entered the geo-fence. For example, if the geo-fence management module 512 is disconnected from one or more wireless signal generators that are registered in the geo-fence, the geo-fence management module may determine that the electronic device 500 is out of the geo-fence. In this case, the unique identifier refers to unique information by which the wireless signal generator is identified, and may refer to the BSSID of the AP (e.g., a MAC address), or a unique user identifier (UUID) or address of the beacon generator.

According to an embodiment of the present disclosure, when the geo-fence management module 512 determines an entry into the geo-fence, the geo-fence management module 512 may execute one or more application programs or one or more functions, which are related to the geo-fence, or may change at least one mode.

The memory 520 may store instructions or data related to the components that constitute the electronic device 500.

According to an embodiment of the present disclosure, the memory 520 may associate a variable identifier of a first wireless signal generator with a point of interest and store the same. For example, the memory 520 may store the variable identifier of the first wireless signal generator in a corresponding geo-fence table. Then, the geo-fence table may store a fixed identifier of the first wireless signal generator.

According to an embodiment of the present disclosure, if a variable identifier of a second wireless signal generator is the same, at least in part, as a variable identifier of a first wireless signal generator, the memory 520 may additionally store information (e.g., a unique identifier) on the second wireless signal generator in a geo-fence table that is stored in the associated memory 520.

The display 530 may display a variety of content (e.g., text, images, videos, icons, symbols, etc.) to a user.

The input module 540 may transfer commands or data received from a user or other external devices for controlling the operation of the electronic device 500 to other components of the electronic device 500. For example, the input module 540 may include a keypad, a dome switch, physical buttons, a touch pad (in a pressure-sensitive type/capacitive type touch pad), a jog & shuttle, or the like.

The communication module 550 may transmit and receive signals between the electronic device 500 and the external devices (for example, external electronic devices or a server). For example, the communication module 550 may include at least one of WiFi, Bluetooth, NFC, or BLE, as a non-cellular protocol.

According to an embodiment of the present disclosure, a mobile electronic device may include an electronic device housing; a non-cellular communication module that is contained in the electronic device housing; a battery that is contained in the electronic device housing; a processor that is contained in the electronic device housing and is electrically connected to the communication module; a user interface that is operatively connected to the processor; and a memory that is electrically connected to the processor and stores instructions that, during execution, allow the processor to receive a first variable identifier and a first unique identifier from a first wireless signal generator in the geographical area including a plurality of wireless signal generators through the communication module, to provide the first variable identifier through the user interface, to associate the first variable identifier with a first point of interest and store the same in the memory, to receive a second variable identifier and a second unique identifier from a second wireless signal generator among the plurality of wireless signal generators through the communication module, and to automatically associate the second variable identifier with the first point of interest, based on whether or not the second variable identifier is the same, at least in part, as the first variable identifier, and store the same in the memory.

According to an embodiment of the present disclosure, a plurality of wireless signal generators may include one or more access points and/or one or more beacon generators.

According to an embodiment of the present disclosure, a first wireless signal generator may include an access point, and a first variable identifier may be an SSID. The first unique identifier may be a BSSID.

According to an embodiment of the present disclosure, an access point may include a device that is based on the WiFi protocol.

According to an embodiment of the present disclosure, a first wireless signal generator may include a beacon generator, and a first variable identifier may be a service name. A first unique identifier may be a UUID or an address.

According to an embodiment of the present disclosure, a beacon generator may include a device that is based on the Bluetooth protocol.

According to an embodiment of the present disclosure, instructions may allow a processor, when the electronic device leaves a geographical area and then re-enters the geographical area to thereby receive a second variable identifier and a second unique identifier from a second wireless signal generator through a communication module, to provide information stating that the electronic device is located in a first point of interest through a user interface, or to provide a service that is related to the first point of interest.

According to an embodiment of the present disclosure, each of a first variable identifier and a second variable identifier may include a sequence including one or more letters and/or one or more numbers.

According to an embodiment of the present disclosure, instructions may allow a processor, if at least 50% of the sequence of a first variable identifier is the same as the sequence of a second variable identifier, to automatically associate a second variable identifier with a first point of interest and store the same in a memory.

According to an embodiment of the present disclosure, a user interface may include a display device, and instructions may allow a processor to display a first variable identifier on the display.

According to an embodiment of the present disclosure, instructions may allow a processor in a state in which the processor no longer receives a first variable identifier and a first unique identifier from a first wireless signal generator through a communication module, to receive a second variable identifier and a second unique identifier from a second wireless signal generator through the communication module; receive a third variable identifier and a third unique identifier from a third wireless signal generator among a plurality of wireless signal generators through the communication module; and to automatically associate the third variable identifier with a first point of interest based on whether or not the third variable identifier is the same, at least in part, as the second variable identifier and store the same in the memory.

According to an embodiment of the present disclosure, instructions may allow a processor, if the processor no longer receives a first variable identifier and a first unique identifier from a first wireless signal generator through a communication module, and if the processor no longer receives a second variable identifier and a second unique identifier from a second wireless signal generator through the communication module, to stop a process of associating a first point of interest with a new wireless signal generator in a geographical area.

According to an embodiment of the present disclosure, instructions may allow a processor to store the instructions that allow the processor, if a second variable identifier is the same, at least in part, as a first variable identifier, automatically associate the second variable identifier with a first point of interest, based on at least one of a signal strength of a second wireless signal generator or information on the cell that contains the second wireless signal generator, and store the same in the memory.

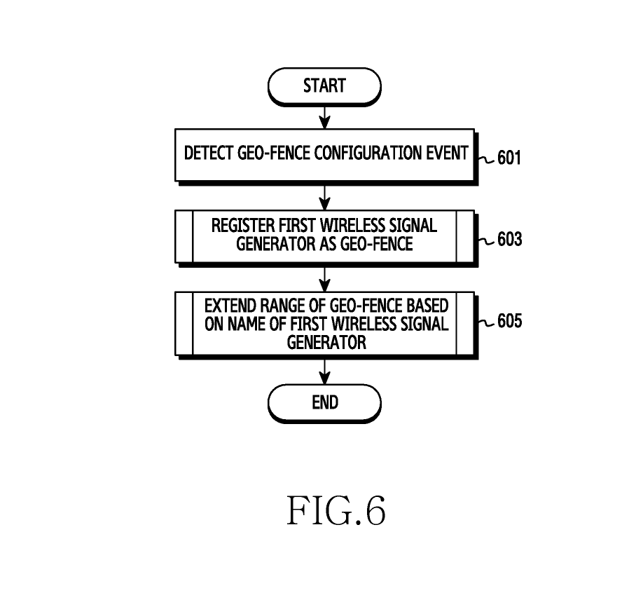

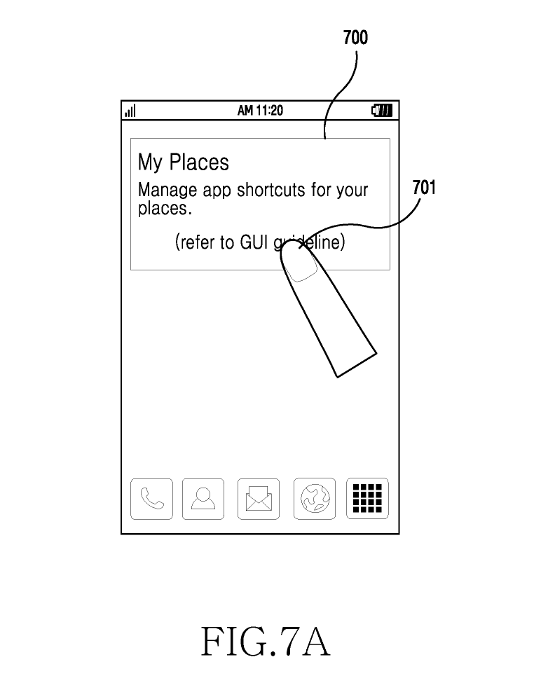

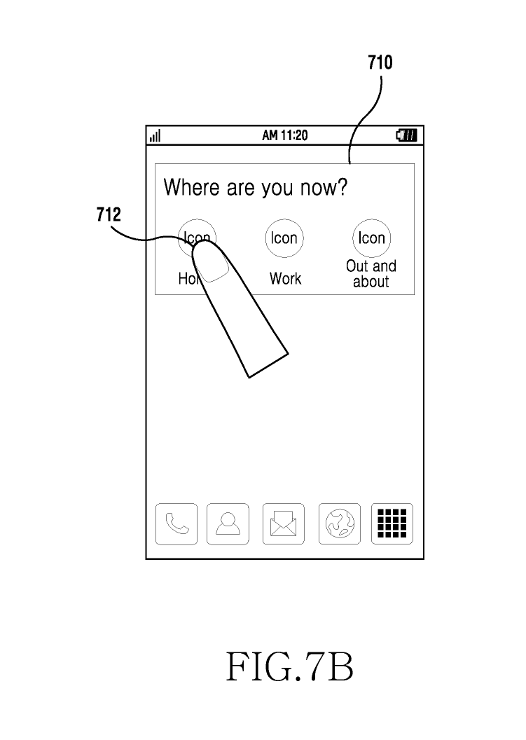

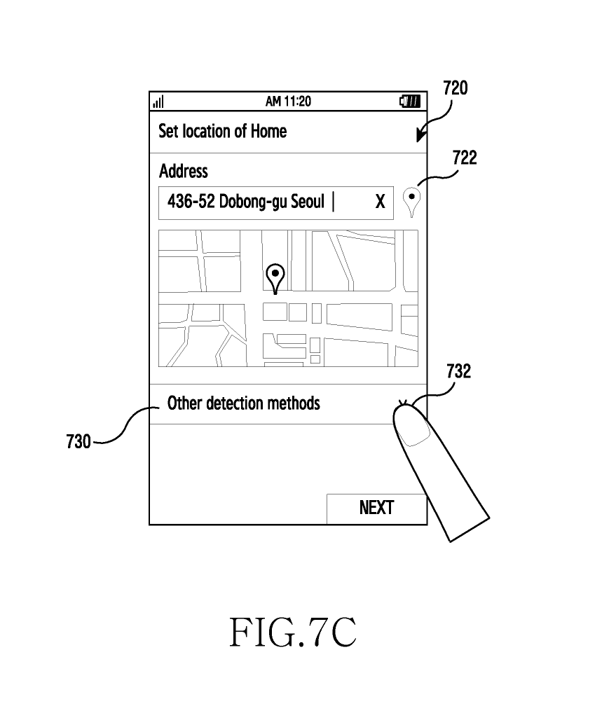

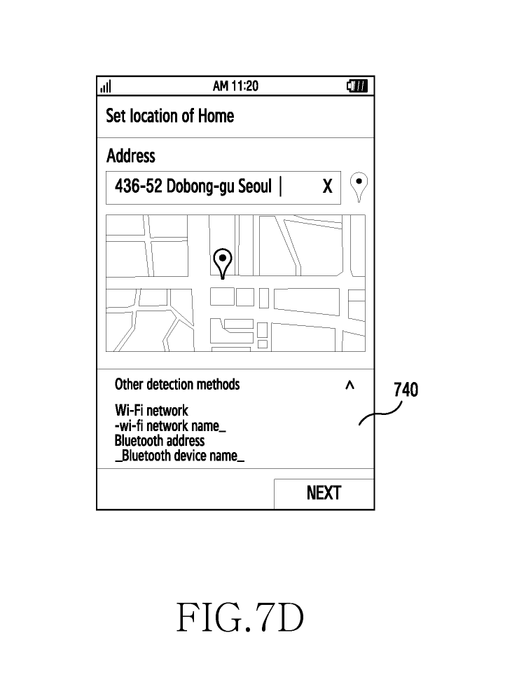

FIG. 6 is a flowchart of a method of configuring a geo-fence in an electronic device, according to an embodiment of the present disclosure. Hereinafter, the method of configuring the geo-fence will be described with reference to the screen configuration shown in FIG. 7A to FIG. 7D.

Referring to FIG. 6, in operation 601, the electronic device (e.g., the electronic device 101, 201 or 500) may detect the occurrence of an event for configuring the geo-fence. For example, the processor 120 of the electronic device 100 may identify whether or not the geo-fence application 400 for the configuration of the geo-fence is executed, based on input information that is detected through the input interface 140. If the geo-fence application 400 is executed, the electronic device may display a geo-fence configuration menu 700 on the display 530 as shown in FIG. 7A. When the selection 701 of the geo-fence configuration menu 700 is detected, the electronic device may display a location determination screen 710 on the display 530 as shown in FIG. 7B. For example, the location determination screen 710 may contain information (e.g., icons) on a predetermined location (e.g., home or an office) to be configured as the geo-fence, and a location adding icon. When the selection for the icon “home” 712 is detected in the location determination screen 710, the electronic device may display the geo-fence configuration screen 720 for “home” on the display 530. For example, the geo-fence configuration screen 720 may include a detection method configuration menu 730 for determining a wireless signal measurement method to detect the geo-fence. Additionally, the geo-fence configuration screen 720 may include map information 722 that shows the location of “home” on the basis of the address of “home.” When the selection 732 for the detection method configuration menu 730 is detected, the electronic device, as shown in FIG. 7D, may display a list of wireless signal measurement methods 740 (for example, WiFi or Bluetooth) that is available for detecting the geo-fence. The electronic device may determine the wireless signal measurement method that is selected from the list of wireless signal measurement methods 740 according to the input information as the wireless signal measurement method for detecting the “home” geo-fence.

In operation 603, the electronic device may register a first network in the geo-fence. For example, the processor 510 of the electronic device 500 may configure, as the geo-fence, a first wireless signal generator that is selected based on the input information detected through the input interface 140 among the network scan list 420 with respect to the wireless signal measurement method for detecting the geo-fence. For example, the processor 510 may configure, as the geo-fence, the first wireless signal generator to which the electronic device 500 is connected at the time of the occurrence of the event for the configuration of the geo-fence. According to an embodiment of the present disclosure, when the geo-fence is configured, the processor 510 may associate one or more application programs, one or more functions, or one or more mode changes with the geo-fence.

In operation 605, the electronic device may extend the range of the geo-fence based on a variable identifier (e.g., a name) of the first wireless signal generator that is registered in the geo-fence. For example, if a second wireless signal generator with a variable identifier, which is the same, at least in part, as the variable identifier of the first wireless signal generator, is discovered in the geo-fence, the processor 510 may register the second wireless generator in the geo-fence. Additionally, the processor 510 may selectively register the second wireless signal generator in the geo-fence based on at least one of signal strength {e.g., a received signal strength indication (RSSI)} of the second wireless signal generator or the information (e.g., a cell ID) on the cell that contains the second wireless signal generator.

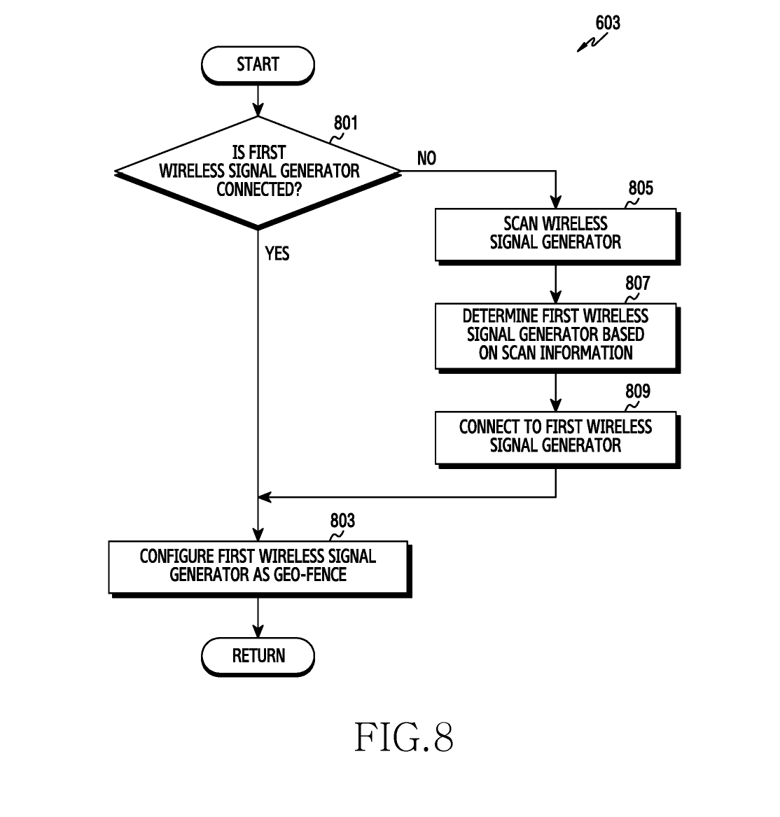

FIG. 8 is a flowchart of a method of registering a first wireless signal generator in a geo-fence in an electronic device, according to an embodiment of the present disclosure. Hereinafter, the method of registering the first wireless signal generator in the geo-fence in operation 603 of FIG. 6 is described.

Referring to FIG. 8, in operation 801, the electronic device 101, 201 or 500 may identify whether or not the electronic device is connected to a wireless signal generator at the time when the event for configuring the geo-fence occurs. For example, the processor 510 may identify whether or not there is an AP to which the electronic device 500 is connected at the time of the occurrence of the event for the configuration of the geo-fence.

In operation 803, if the electronic device is connected to a first wireless signal generator, the electronic device may configure the first wireless signal generator as the geo-fence. For example, the processor 510 may register a variable identifier (e.g., a name (e.g. an SSID)) and a unique identifier (e.g., a MAC address (e.g. a BSSID)) of the first wireless signal generator in the geo-fence.

In operation 805, if the electronic device is not connected to the first wireless signal generator, the electronic device may scan (e.g. search) for a wireless signal generator.

In operation 807, the electronic device may determine the first wireless signal generator based on the wireless signal generator scan information (e.g., the scan list). For example, the processor 510 may select one wireless signal generator as the first wireless signal generator from among the wireless signal generator scan list. Then, the processor 510 may select the first wireless signal generator based on the input information that is detected through the input module 540.

In operation 809, the electronic device may be connected to the first wireless signal generator. For example, the processor 510 may connect to the AP that has been determined in operation 807.

In operation 803, the electronic device may configure, as the geo-fence, the first wireless signal generator that is connected in operation 809. For example, the processor 510 may register the name (e.g., Name 1) and the identifier (e.g., the MAC address (aa:bb:cc:dd:ee)) of the first wireless signal generator in the geo-fence table 430 as shown in FIG. 4.

According to an embodiment of the present disclosure, even if the electronic device is connected to the wireless signal generator at the time when the event for configuring the geo-fence occurs, the electronic device may scan the wireless signal generator in step 805.

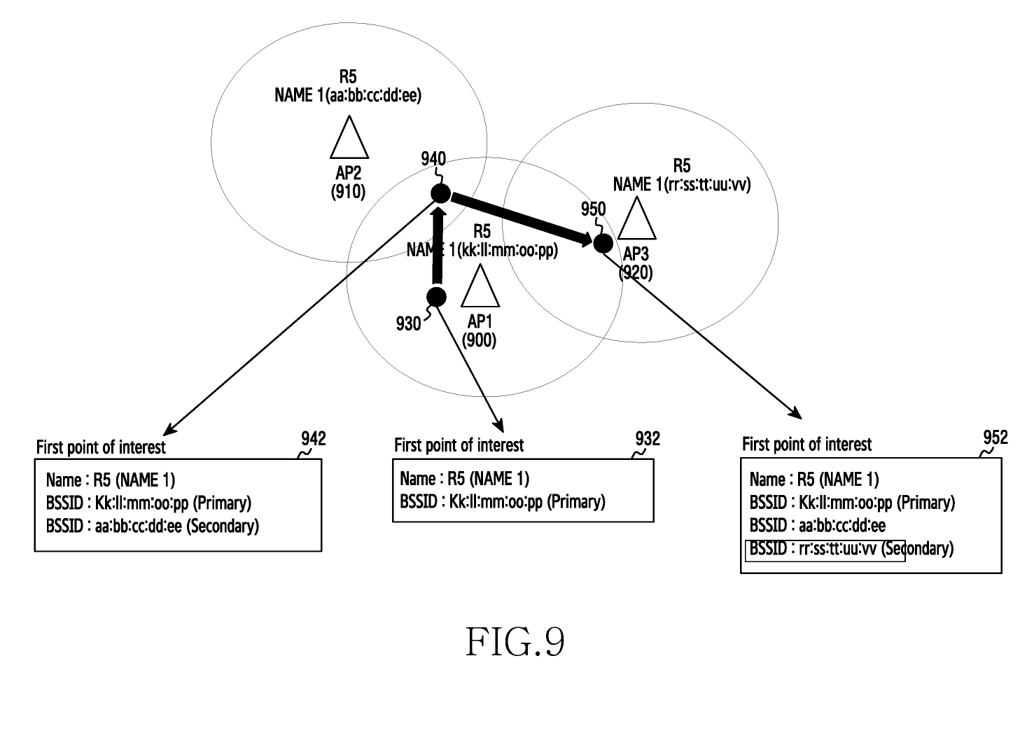

FIG. 9 illustrates a network structure for configuring and extending a geo-fence, according to an embodiment of the present disclosure.

Referring to FIG. 9, when the electronic device 101, 201 or 500 is located in a first location 930, the electronic device may receive a first variable identifier and a first unique identifier of a first wireless signal generator (API) 900.

The electronic device may associate the first variable identifier (e.g., NAME 1) of the first wireless signal generator 900 with the first point of interest, and may store the same in a memory. For example, the electronic device may configure the first wireless signal generator 900 as the geo-fence. Accordingly, the electronic device may store the first variable identifier and the first unique identifier (e.g., kk:ll:mm:oo:pp) of the first wireless signal generator 900 in a geo-fence table 932.

According to an embodiment of the present disclosure, when the electronic device moves to a second location 940, the electronic device may receive a second variable identifier of a second wireless signal generator (AP2) 910. If the second variable identifier is the same, at least in part, as the first variable identifier, the electronic device may automatically associate the second wireless signal generator 910 with the first point of interest, and may store the additional information in the memory 520. For example, the electronic device may add the second wireless signal generator 910 to the geo-fence. Accordingly, the electronic device may store a second unique identifier (e.g., aa:bb:cc:dd:ee) of the second wireless signal generator 910 in the geo-fence table 942.

According to an embodiment of the present disclosure, when the electronic device moves to a third location 950, the electronic device may receive a third variable identifier of a third wireless signal generator (AP3) 920. If the third variable identifier is the same, at least in part, as the first variable identifier, the electronic device may automatically associate the third wireless signal generator 920 with the first point of interest, and may store the additional information in the memory 520. Alternatively, if the third variable identifier is the same, at least in part, as the second variable identifier, the electronic device may automatically associate the third wireless signal generator 920 with the first point of interest, and may store the additional information in the memory 520. For example, the electronic device may add the third wireless signal generator 920 to the geo-fence. Accordingly, the electronic device may store a third unique identifier (e.g., rr:ss:tt:uu:vv) of the third wireless signal generator 920 in the geo-fence table 952.

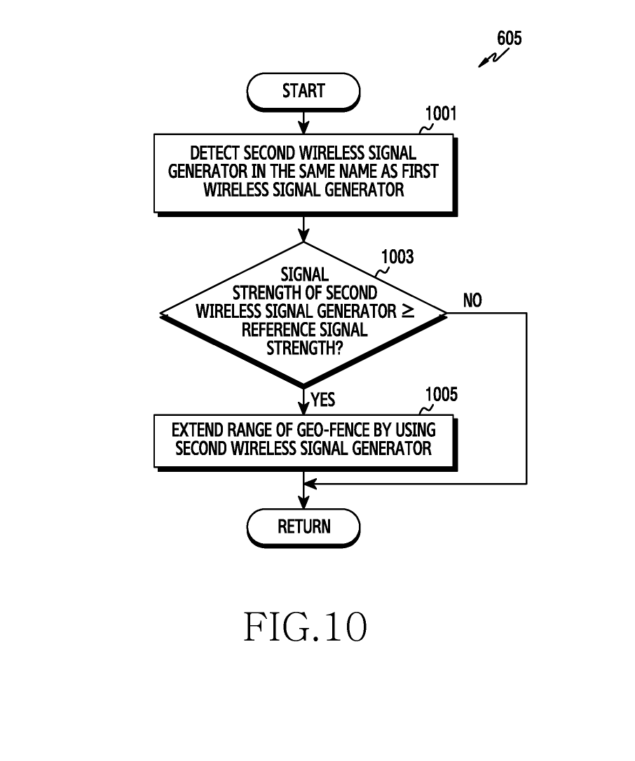

FIG. 10 is a flowchart of a method of extending a range of a geo-fence based on a signal strength of a wireless signal generator in an electronic device, according to an embodiment of the present disclosure. Hereinafter, the operation of extending the range of the geo-fence in operation 605 of FIG. 6 is described.

Referring to FIG. 10, in operation 1001, the electronic device (e.g., the electronic device 101, 201 or 500) may detect a second wireless signal generator of which a variable identifier is the same, at least in part, as a variable identifier (e.g., an SSID) of a first wireless signal generator. For example, the processor 510 may compare a character string of the variable identifier of the second wireless signal generator, which is included in the wireless signal generator scan list, with a character string of the variable identifier of the first wireless signal generator in order to determine the similarity to the name of the network of the first wireless signal generator. The processor 510 may select the wireless signal generator, of which the similarity to the variable identifier of the first wireless signal generator is greater than a reference percentage value (e.g., 50%) as the second wireless signal generator in the same name as the first wireless signal generator.

In operation 1003, the electronic device may determine whether or not the signal strength of the second wireless signal generator is greater than or equal to the reference signal strength (e.g., −84 dBm). For example, the processor 510 may compare the signal strength of the second wireless signal generator, which is measured during the scan of the wireless signal generator, with the reference signal strength.

In operation 1005, if the signal strength of the second wireless signal generator is greater than or equal to the reference signal strength, the electronic device may extend the range of the geo-fence by using the second wireless signal generator. For example, in the case of FIG. 4, the processor 510 may select the wireless signal generators (e.g., wireless signal generators with unique identifiers “aa:bb:cc:zz:yy,” “ff:gg:hh:ii:jj,” and “aa:bb:cc:ff:gg”) of which the variable identifiers are similar, at least in part, to the variable identifier of the first wireless signal generator (e.g., Name 1 (aa:bb:cc:dd:ee)) from among the wireless LAN scan list 420. The processor 510 may register, in the geo-fence, the second wireless signal generators of “aa:bb:cc:zz:yy” and “ff:gg:hh:ii:jj,” which have a greater signal strength than the reference signal strength, among the second wireless signal generators of which the variable identifiers are the same, at least in part, as the variable identifier of the first wireless signal generator.

According to an embodiment of the present disclosure, if the signal strength of the second wireless signal generator is less than a predetermined reference signal strength, the electronic device may maintain the range of the geo-fence to be the signal range of the first wireless generator. That is, the electronic device may limit the configuration and extension of the geo-fence by using the wireless signal generator that has a signal strength less than the reference signal strength. For example, the processor 510 may limit the extension of the range of the geo-fence by using the wireless signal generator of “aa:bb:cc:ff:gg” that has a smaller signal strength than the reference signal strength, among the second wireless signal generators of which the names are the same, at least in part, as the first wireless signal generator.

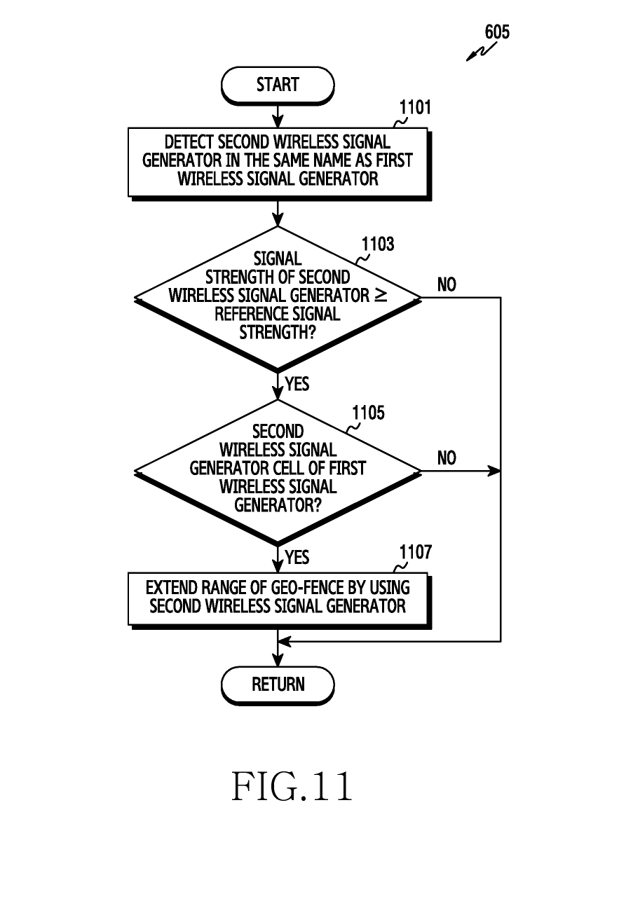

FIG. 11 is a flowchart of a method of extending a range of a geo-fence on the basis of the cell that contains a network in an electronic device, according to an embodiment of the present disclosure. Hereinafter, the operation of extending the range of the geo-fence in operation 605 of FIG. 6 is described.

Referring to FIG. 11, in operation 1101, the electronic device (e.g., the electronic device 101, 201 or 500) may detect a second wireless signal generator of which the name is the same, at least in part, as a first wireless signal generator. For example, the processor 510 may detect the second wireless signal generator in a network that is named the same, at least in part, as the name of the network of the first wireless signal generator based on the similarity between the name of the network of the first wireless signal generator and the name of the network of the wireless signal generators that are contained in the wireless signal generator scan list.

In operation 1103, the electronic device may determine whether or not the signal strength of the second wireless signal generator is greater than or equal to the reference signal strength (e.g., −84 dBm). For example, the processor 510 may compare the signal strength of the second wireless signal generator when scanning the wireless signal generator with the reference signal strength.

In operation 1105, if the signal strength of the second wireless signal generator is greater than or equal to the reference signal strength, the electronic device may identify whether or not the second wireless signal generator is contained in the cell of the first wireless signal generator. For example, the processor 510 may identify whether or not the second wireless signal generator, which has a greater signal strength than the reference signal strength, is contained in the cell to which the first wireless signal generator belongs.

In operation 1107, if the second wireless signal generator is contained in the cell of the first wireless signal generator, the electronic device may extend the range of the geo-fence by using the second wireless signal generator. For example, if the second wireless signal generator, which has a signal strength greater than the reference signal strength, is located in the cell of the first wireless signal generator, the processor 510 may register the identification information of the second wireless signal generator in the geo-fence.

According to an embodiment of the present disclosure, if the signal strength of the second wireless signal generator, of which the name is the same, at least in part, as the first wireless signal generator, is less than the reference signal strength, or if the second wireless signal generator is located in a cell different from the cell of the first wireless signal generator, the electronic device may maintain the range of the geo-fence to be the signal range of the first wireless signal generator.

According to an embodiment of the present disclosure, if the second wireless signal generator, of which the name is the same, at least in part, as the first wireless signal generator, is contained in the reference cell area, the electronic device may extend the range of the geo-fence by using the second wireless signal generator. In this case, the reference cell area may include the first cell that contains the first wireless signal generator and one or more second cells that are adjacent to the first cell.

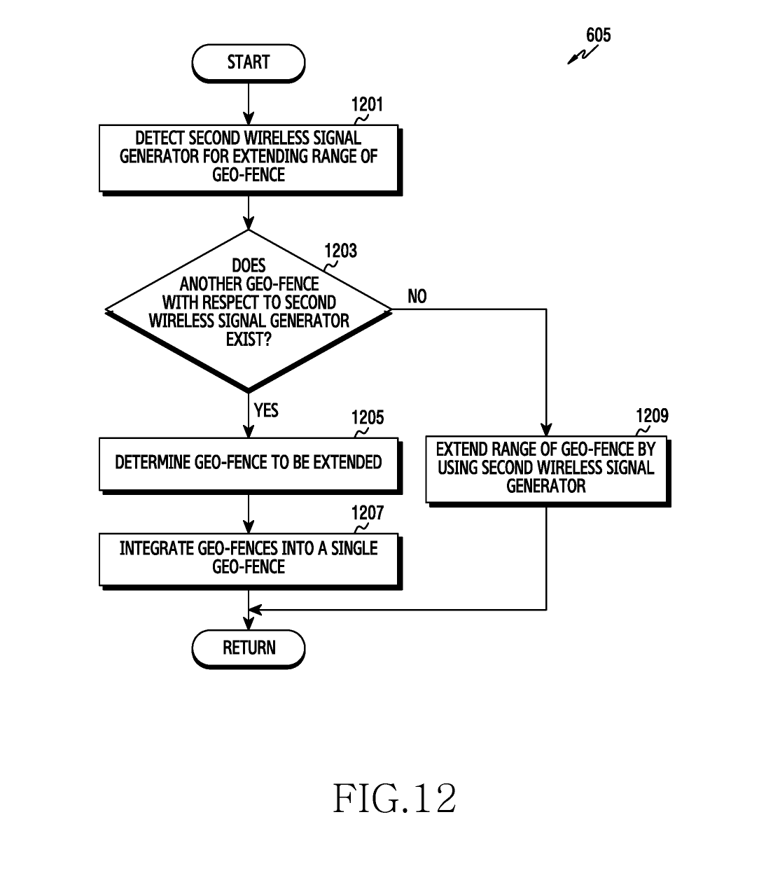

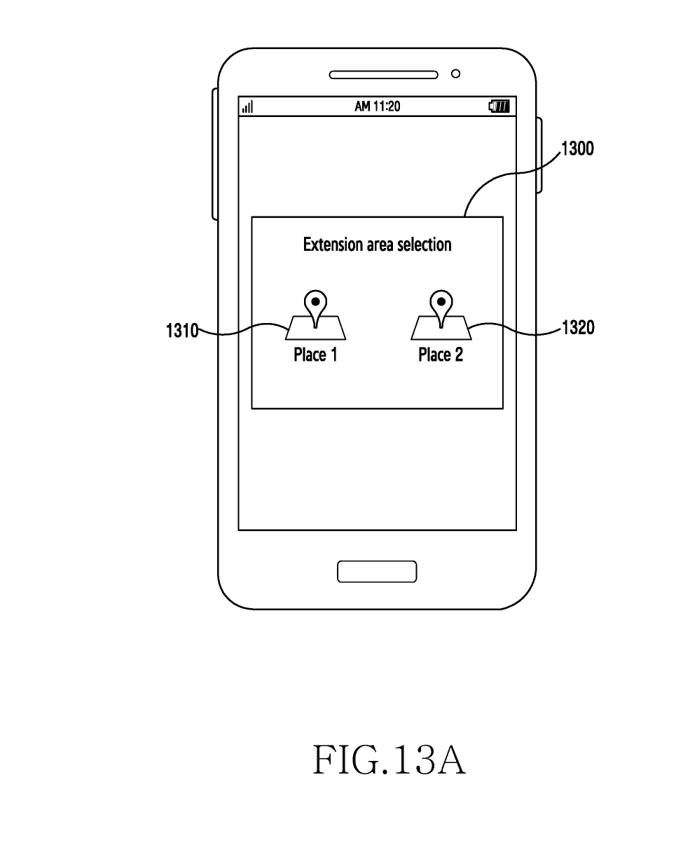

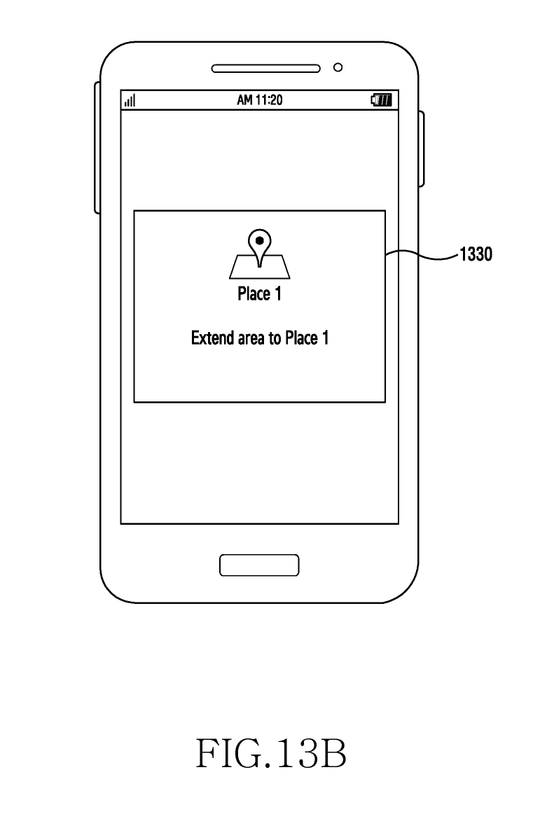

FIG. 12 is a flowchart of a method of integrating geo-fences in an electronic device, according to an embodiment of the present disclosure. Hereinafter, the operation of extending the range of the geo-fence in operation 605 of FIG. 6 is described. Additionally, the operation of integrating the geo-fences is described with reference to the screen configuration shown in FIG. 13A and FIG. 13B.

Referring to FIG. 12, in operation 1201, the electronic device (e.g., the electronic device 101, 201 or 500) may detect a second wireless signal generator for extending the range of the geo-fence based on the name of a first wireless signal generator. For example, the processor 510 may detect the second wireless signal generator in a network that is named the same, at least in part, as the name of the network of the first wireless signal generator based on the similarity between the name of the network of the first wireless signal generator and the name of the network of the wireless signal generators that are contained in the network scan list. Additionally, the processor 120 may additionally select the second wireless signal generator based on at least one of the signal strength of the second wireless signal generator or cell information, which contains the second wireless signal generator.

In operation 1203, the electronic device may determine whether or not the second wireless signal generator for extending the range of the geo-fence is contained in another geo-fence. For example, the processor 510 may determine whether or not the identification information on the second wireless signal generator is contained in a table of another geo-fence, which is stored in the memory 520.

If it is determined that the second wireless signal generator for extending the range of the geo-fence is contained in another geo-fence, the electronic device may determine the geo-fence to be integrated (e.g. extended) in operation 1205. For example, if it is determined that the second wireless signal generator for extending the range of the geo-fence is contained in another geo-fence, the processor 510, as shown in FIG. 13A, may display a geo-fence selection screen 1300 on the display 530. For example, the geo-fence selection screen 1300 may include Place 1 1310, which is a geo-fence to be extended by using the second wireless signal generator and Place 2 1320, which is another geo-fence including the second wireless signal generator. When one geo-fence to be integrated is selected through the geo-fence selection screen 1300 that is displayed on the display 530, the processor 510 may display the selected geo-fence information (e.g., Place 1 1330) on the display 530 as shown in FIG. 13B.

In operation 1207, the electronic device may integrate the geo-fences that correspond to the second wireless signal generator into a single geo-fence that is selected in operation 1205. For example, the processor 510 may integrate the range of Place 1 1310 and the range of Place 2 1320 into the range of Place 1 1310.

In operation 1209, if it is determined that the second wireless signal generator to be registered in the geo-fence is not contained in another geo-fence, the electronic device may extend the range of the geo-fence by using the second wireless signal generator. For example, the processor 510 may add the identification information of the second wireless signal generator to the geo-fence table.

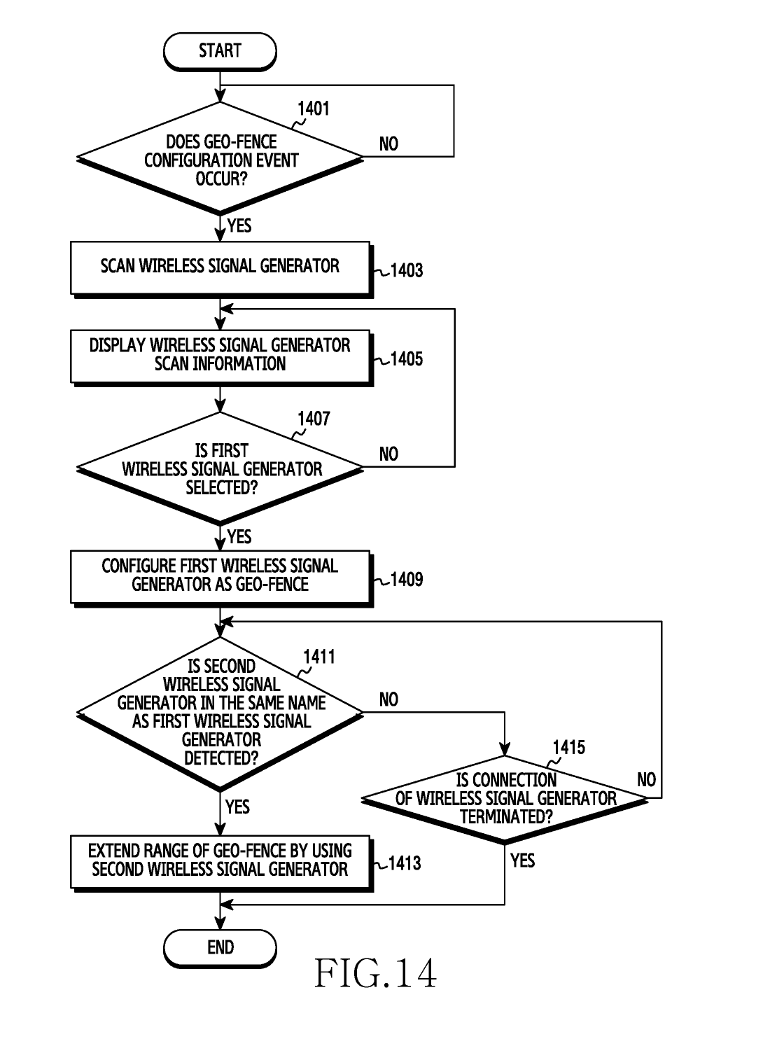

FIG. 14 is a flowchart of a method of configuring and extending a geo-fence based on a wireless signal generator name in an electronic device, according to an embodiment of the present disclosure.

Referring to FIG. 14, in operation 1401, the electronic device 101, 201 or 500 may determine whether or not an event for configuring a geo-fence occurs.

For example, the processor 510 may determine whether or not the geo-fence application 400 is executed for the configuration of a geo-fence based on input information that is detected through the input module 540.

In operation 1403, when an event for the configuration of a geo-fence occurs, the electronic device may scan the wireless signal generator. For example, the processor 510 may scan the AP that is adjacent to the electronic device 500 through the communication module 550.

In operation 1405, the electronic device may display the scan information of the wireless signal generator on the display (e.g., the display 530). For example, the processor 510 may display the AP scan list on the display 530. If a plurality of APs, which have the same variable identifier, are scanned, the processor 510 may change the access point scan list to include a single AP that has a greatest signal strength among the APs of the same variable identifier, and may display the same on the display 530.

In operation 1407, the electronic device may determine whether or not the first wireless signal generator, to which the electronic device is connected, is selected based on the input information with respect to the wireless signal generator scan list that is displayed on the display.

If the first wireless signal generator is not selected, the electronic device, in operation 1405, may maintain the display of the scan information of the wireless signal generator.

If the first wireless signal generator is selected, the electronic device, in operation 1409, may configure the first wireless signal generator as the geo-fence. For example, the processor 510 may register the unique identifier of the first wireless signal generator as the geo-fence.

In operation 1411, the electronic device may identify whether or not the second wireless signal generator, of which the variable identifier is the same, at least in part, as the variable identifier of the first wireless signal generator, is detected. For example, the electronic device may identify whether or not the second wireless signal generator, of which the variable identifier is the same, at least in part, as the variable identifier of the first wireless signal generator, exists in the wireless signal generator scan list. For example, the wireless signal generator scan list may include the scan information on the wireless signal generators that have been scanned to select the first wireless signal generator or the scan information on the wireless signal generators that have been periodically scanned by the electronic device in the range of the geo-fence in operation 1403.

If the second wireless signal generator, of which the variable identifier is the same, at least in part, as the variable identifier of the first wireless signal generator, is not detected, the electronic device, in operation 1415, may identify whether or not the electronic device is disconnected (e.g. terminated) from the wireless signal generator that is registered in the geo-fence.

If the electronic device is not disconnected from the wireless signal generator that is registered in the geo-fence, the electronic device, in operation 1411, may re-identify whether or not the second wireless signal generator, of which the variable identifier is the same, at least in part, as the variable identifier of the first wireless signal generator, is detected.

If the second wireless signal generator, of which the variable identifier is the same, at least in part, as the variable identifier of the first wireless signal generator, is detected, the electronic device, in operation 1413, may extend the range of the geo-fence by using the second wireless signal generator. For example, the processor 510 may additionally register the identification information of the second wireless signal generator in the geo-fence table.

According to an embodiment of the present disclosure, the processor 510 may selectively extend the range of the geo-fence based on at least one of the signal strength of the second wireless signal generator, of which the name is the same, at least in part, as the variable identifier of the first wireless signal generator, or the information on the cell that contains the second wireless signal generator.

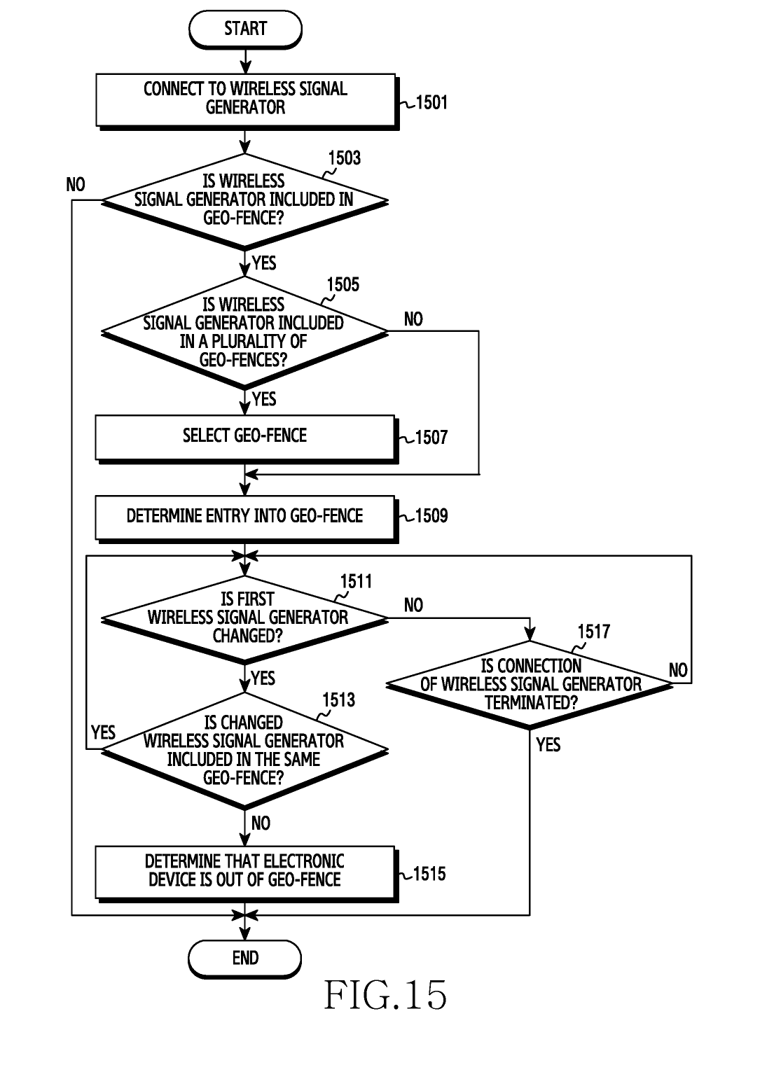

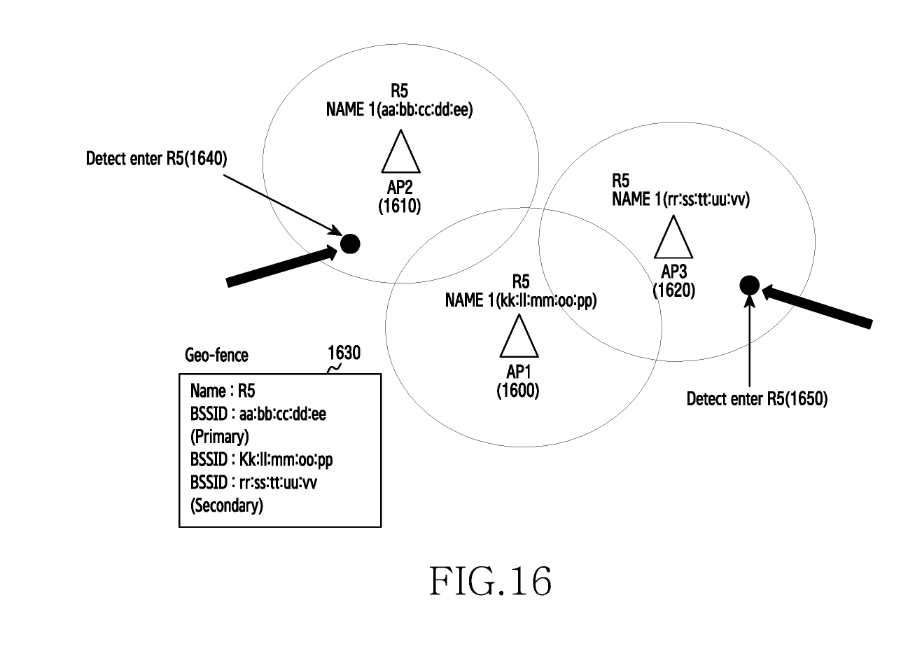

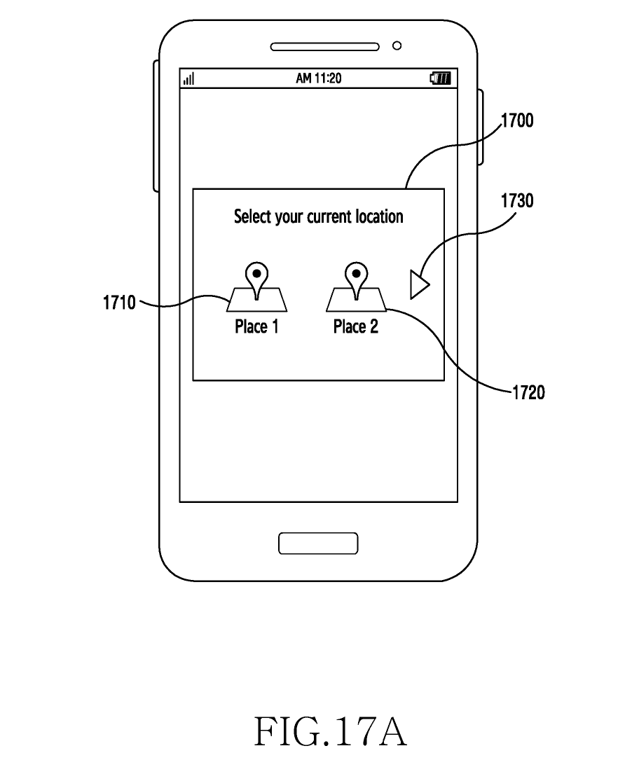

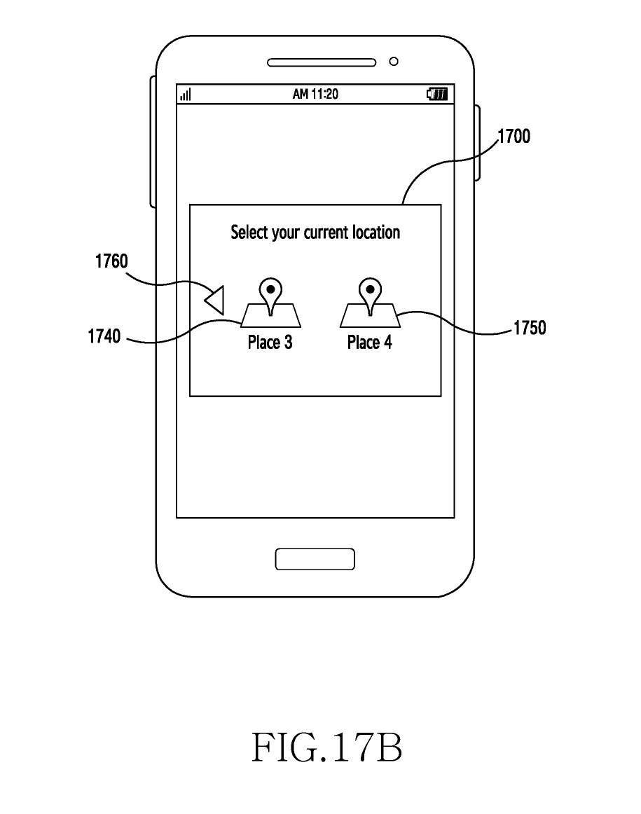

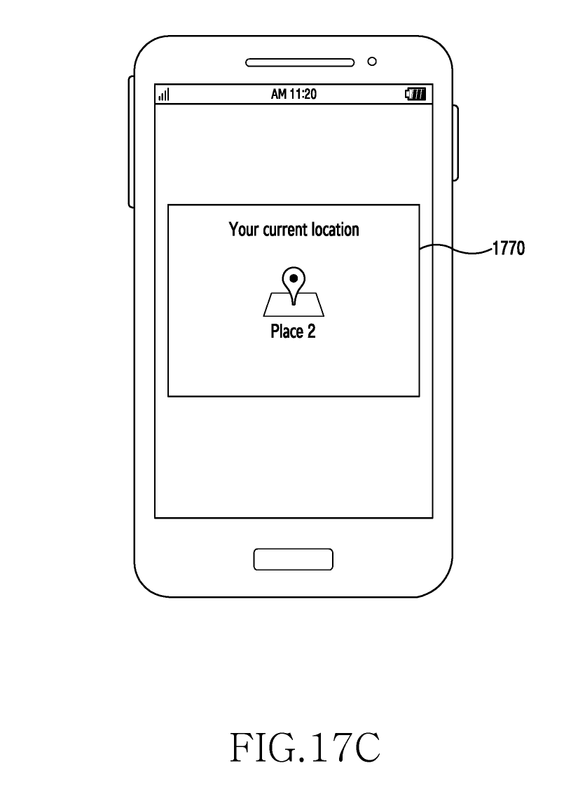

FIG. 15 is a flowchart of a method of determining a location based on a geo-fence in an electronic device, according to an embodiment of the present disclosure. Hereinafter, the operation of determining the entry into the geo-fence is described with reference to the network structure shown in FIG. 16 and the screen configuration shown in FIG. 17A to FIG. 17C.

Referring to FIG. 15, in operation 1501, the electronic device (e.g., the electronic device 101, 201 or 500) may be connected to a wireless signal generator. For example, the processor 510 may access an AP based on wireless LAN scan information.

In operation 1503, the electronic device may identify whether or not the first wireless signal generator is contained in a geo-fence. For example, the processor 120 may identify whether or not the identification information on the first wireless signal generator is contained in a geo-fence table that is stored in the memory 520.

If the first wireless signal generator is contained in a geo-fence, the electronic device, in operation 1505, may identify whether or not the first wireless signal generator is contained in a plurality of geo-fences. For example, the electronic device may identify whether or not there are a plurality of geo-fence tables that contain the identification information of the first wireless signal generator.

If the first wireless signal generator is contained in a single geo-fence, the electronic device, in operation 1509, may determine that the electronic device has entered the corresponding geo-fence. For example, in the case of FIG. 16, when the processor 510 is connected to a second wireless signal generator (AP2) 1610, the processor 510 may receive a second unique identifier of the second wireless signal generator 1610. If the second unique identifier is a registered unique identifier in the geo-fence table 1630, the processor 510 may determine that the electronic device 500 has entered the geo-fence “R5” 1640. That is, even though the processor 510 is not connected to a first wireless signal generator (AP1) 1600 that is initially registered in the geo-fence “R5,” the processor 510 may determine that the electronic device has entered the geo-fence “R5” based on the second wireless signal generator (AP2) 1610. For example, when the processor 510 is connected to third wireless signal generator (AP3) 1620, the processor 510 may receive a third unique identifier of a third wireless signal generator 1620. If the third unique identifier is a registered unique identifier in the geo-fence table 1630, the processor 510 may determine that the electronic device 500 has entered the geo-fence “R5” 1640. According to an embodiment of the present disclosure, when the processor 510 determines an entry into a geo-fence, the processor 510 may execute one or more application programs or one or more functions, which are related to the geo-fence, or may change at least one mode.

If the first wireless signal generator is contained in a plurality of geo-fences, the electronic device, in operation 1507, may select one of the plurality of geo-fences that include the first wireless signal generator. For example, if the first wireless signal generator is contained in a plurality of geo-fences, the processor 510 may display a geo-fence selection screen 1700 on the display 530 as shown in FIG. 17A. If the geo-fence of Place 2 1720 is selected through the geo-fence selection screen 1700 that is displayed on the display 530, the processor 510 may display the selected geo-fence information (e.g., Place 2) 1770 on the display 530 as shown in FIG. 17C. For example, the geo-fence selection screen 1700 may include Place 1 1710 and Place 2 1720, which are geo-fences in which the first wireless signal generator is contained. Additionally, if there is another geo-fence in which the first wireless signal generator is contained, the geo-fence selection screen 1700 may include a geo-fence change icon 1730. When the selection of the geo-fence change icon 1730 is detected in FIG. 17A, the processor 510 may change the geo-fence, which is displayed on the geo-fence selection screen 1700, into Place 3 1740 and Place 4 1750 as shown in FIG. 17B. Additionally, the geo-fence selection screen 1700 may include a geo-fence change icon 1760 for converting the geo-fence selection screen 1700 to the screen as shown in FIG. 17A.

In operation 1509, the electronic device may determine that the electronic device has entered the geo-fence that is selected in operation 1507 among the plurality of geo-fences that contain the first wireless signal generator. Accordingly, the electronic device may generate an event corresponding to the entry into the geo-fence. For example, the electronic device may provide an advertisement service in response to the entry into the geo-fence. The electronic device may execute an application program in response to the entry into the geo-fence. The electronic device may change the configuration menu in response to the entry into the geo-fence.

In operation 1511, the electronic device may identify whether or not the first wireless signal generator is changed.

If the first wireless signal generator is not changed, the electronic device, in operation 1517, may identify whether or not the connection of the first wireless signal generator is terminated.

If the connection of the wireless signal generator is not terminated, the electronic device, in operation 1511, may re-identify whether or not the first wireless signal generator is changed.

If the first wireless signal generator is changed, the electronic device, in operation 1513, may identify whether or not the first changed wireless signal generator is contained in the same geo-fence as the wireless signal generator that has been previously connected. For example, the processor 510 may identify whether or not the first changed wireless signal generator is contained in the same geo-fence as the wireless signal generator that has been previously connected, based on the information on the wireless signal generator that is registered in each geo-fence, which is stored in memory 520.

If the first changed wireless signal generator is contained in the same geo-fence as the wireless signal generator that has been previously connected, the electronic device may determine that the electronic device is located in the geo-fence. According to this, the electronic device may re-identify whether or not the first wireless signal generator is changed in operation 1511.

If the first changed wireless signal generator is not contained in the same geo-fence as the wireless signal generator that has been previously connected, the electronic device, in operation 1515, may determine that the electronic device is out of the geo-fence.

According to an embodiment of the present disclosure, a method of a mobile electronic device may include receiving a first variable identifier and a first unique identifier from a first wireless signal generator in a geographical area including a plurality of wireless signal generators; providing the first variable identifier through a user interface of the mobile electronic device; associating the first variable identifier with a first point of interest and storing the same; receiving a second variable identifier and a second unique identifier from a second wireless signal generator among the plurality of wireless signal generators; and automatically associating the second variable identifier with the first point of interest, based on whether or not the second variable identifier is the same, at least in part, as the first variable identifier, and storing the same.

According to an embodiment of the present disclosure, the method may further include, if the electronic device leaves the geographical area and then re-enters the geographical area to thereby receive the second variable identifier and the second unique identifier from the second wireless signal generator, providing information stating that the electronic device is located in the first point of interest through the user interface, or providing a service that is related to the first point of interest.

According to an embodiment of the present disclosure, the operation of automatically associating the second variable identifier with the first point of interest and storing the same may include, if at least 50% of the sequence of the first variable identifier is the same as the sequence of the second variable identifier, automatically associating the second variable identifier with the first point of interest and storing the same.

According to an embodiment of the present disclosure, the operation of providing through the user interface may include displaying the first variable identifier on the display of the user interface.

According to an embodiment of the present disclosure, the method may further include, in a state in which the first variable identifier and the first unique identifier are not received from the first wireless signal generator, receiving the second variable identifier and the second unique identifier from the second wireless signal generator; receiving the third variable identifier and the third unique identifier from the third wireless signal generator among the plurality of wireless signal generators; and automatically associating the third variable identifier with the first point of interest, based on whether or not the third variable identifier is the same, at least in part, as the second variable identifier, to then be stored.

According to an embodiment of the present disclosure, the method may further include, if the first variable identifier and the first unique identifier are not received from the first wireless signal generator, and if the second variable identifier and the second unique identifier are not received from the second wireless signal generator, stopping the process of associating the first point of interest with a new wireless signal generator in the geographical area and storing the same.

According to an embodiment of the present disclosure, the operation of automatically associating the second variable identifier with the first point of interest and storing the same may include, if the second variable identifier is the same, at least in part, as the first variable identifier, automatically associating the second variable identifier with the first point of interest, based on at least one of the signal strength of the second wireless signal generator or information on the cell that contains the second wireless signal generator and storing the same.

The electronic device and the method thereof may configure a geo-fence based on a variable identifier of at least one wireless signal generator to actively configure a range of the geo-fence.

The term “module” as used herein may, for example, indicate a unit including one of hardware, software, firmware, or a combination of two or more of them. The term “module” may be interchangeably used with, for example, the terms “unit,” “logic,” “logical block,” “component,” or “circuit.” The term “module” may be a minimum unit of an integrated component element or a part thereof. The term “module” may refer to a minimum unit for performing one or more functions or a part thereof. The term “module” may be mechanically or electronically implemented. For example, the term “module” according to the present disclosure may include at least one of an application specific IC (ASIC), a field programmable gate array (FPGA), and a programmable-logic device for performing operations which are known or may be developed hereinafter.

According to an embodiment of the present disclosure, at least some of the devices (for example, modules or functions thereof) or the method (for example, operations) according to the present disclosure may be implemented by a command stored in a non-transitory computer-readable storage medium in a programming module. When an instruction is implemented by one or more processors (for example, the processor 120), one or more processors may execute a function corresponding to the instruction. The non-transitory computer-readable storage medium may be, for example, the memory 130.

The non-transitory computer readable storage medium may include a hard disk, a floppy disk, magnetic media (for example, a magnetic tape), optical media (for example, a compact disc read only memory (CD-ROM) and a digital versatile disc (DVD)), magneto-optical media (for example, a floptical disk), a hardware device (for example, a ROM, a random access memory (RAM), a flash memory), and the like. In addition, program instructions may include high level language code, which may be executed in a computer by using an interpreter, as well as machine code generated by a compiler. Any of the hardware devices as described above may be configured to work as one or more software modules in order to perform the operations according to an embodiment of the present disclosure, and vice versa.

Any of the modules or programming modules according to an embodiment of the present disclosure may include at least one of the above described elements, exclude some of the elements, or further include other additional elements. The operations performed by the modules, programming module, or other elements according to an embodiment of the present disclosure may be executed in a sequential, parallel, repetitive, or heuristic manner. Further, some operations may be executed according to another order or may be omitted, or other operations may be added.

The embodiments disclosed herein are provided merely to easily describe technical details of the present disclosure and to facilitate understanding of the present disclosure, but are not intended to limit the scope of the present disclosure. Therefore, it is intended that all modifications and changes or various other embodiments based on an embodiment of the present disclosure fall within the scope of the present disclosure as defined in the appended claims and their equivalents.

What is claimed is:

1. A mobile electronic device, comprising:
an electronic device housing;
a non-cellular communication module contained in the electronic device housing;
a battery contained in the electronic device housing;
a processor contained in the electronic device housing and electrically connected to the non-cellular communication module;
a user interface operatively connected to the processor; and
a memory electrically connected to the processor,
wherein the memory stores instructions that, when executed, cause the processor to:
receive a first variable identifier and a first unique identifier from a first wireless signal generator in a geographical area including a plurality of wireless signal generators through the communication module,
provide the first variable identifier through the user interface,
associate the first variable identifier with a first point of interest and storing the association in the memory,
receive a second variable identifier and a second unique identifier from a second wireless signal generator among the plurality of wireless signal generators through the communication module, and
automatically associate the second variable identifier with the first point of interest, based on whether or not the second variable identifier is the same, at least in part, as the first variable identifier, and store the association in the memory.

2. The mobile electronic device of claim 1, wherein the plurality of wireless signal generators includes at least one access point and/or at least one beacon generator.

3. The mobile electronic device of claim 2, wherein the first wireless signal generator includes an access point; the first variable identifier is a service set identifier (SSID); the first unique identifier is a basic service set identifier (BSSID); and the at least one access point includes at least one device that is based on a wireless fidelity (WiFi) protocol.

4. The mobile electronic device of claim 1, wherein the first wireless signal generator includes a beacon generator; the first variable identifier is a service name; the first unique identifier is a unique user identifier (UUID) or an address; and the beacon generator includes a device that is based on a Bluetooth protocol.

5. The mobile electronic device of claim 1, wherein the processor is configured for the instructions to cause the processor, when the mobile electronic device leaves the geographical area and then re-enters the geographical area to thereby receive the second variable identifier and the second unique identifier from the second wireless signal generator through the non-cellular communication module, to provide information stating that the mobile electronic device is located in the first point of interest through the user interface, or to provide a service that is related to the first point of interest.

6. The mobile electronic device of claim 1, wherein each of the first variable identifier and the second variable identifier includes a sequence including at least one letter and/or at least one number.

7. The mobile electronic device of claim 6, wherein the processor is configured for the instructions to cause the processor, if at least 50% of the sequence of the first variable identifier is the same as the sequence of the second variable identifier, to automatically associate the second variable identifier with the first point of interest and to store the association in the memory.

8. The mobile electronic device of claim 1, wherein the user interface includes a display device, and the processor is configured for the instructions to allow the processor to display the first variable identifier on the display device.

9. The mobile electronic device of claim 1, wherein the processor is configured for the instructions to cause the processor, in a state in which the processor no longer receives the first variable identifier and the first unique identifier from the first wireless signal generator through the non-cellular communication module, to receive the second variable identifier and the second unique identifier from the second wireless signal generator through the non-cellular communication module; receive the third variable identifier and the third unique identifier from the third wireless signal generator among the plurality of wireless signal generators through the non-cellular communication module; and automatically associate the third variable identifier with the first point of interest based on whether or not the third variable identifier is the same, at least in part, as the second variable identifier and store the association in the memory.

10. The mobile electronic device of claim 1, wherein the processor is configured for the instructions to cause the processor, if the processor no longer receives the first variable identifier and the first unique identifier from the first wireless signal generator through the non-cellular communication module, and if the processor no longer receives the second variable identifier and the second unique identifier from the second wireless signal generator through the non-cellular communication module, to stop associating the first point of interest with a new wireless signal generator in the geographical area.

11. The mobile electronic device of claim 1, wherein the processor is configured for the instructions to cause the processor to store the instructions that allow the processor, if the second variable identifier is the same, at least in part, as the first variable identifier, to automatically associate the second variable identifier with the first point of interest, based on at least one of a signal strength of the second wireless signal generator or information on a cell that contains the second wireless signal generator, and store the association in the memory.

12. The mobile electronic device of claim 1, wherein the non-cellular communication module includes at least one wireless fidelity module and/or at least one Bluetooth module.

13. A method of a mobile electronic device, the method comprising:
receiving a first variable identifier and a first unique identifier from a first wireless signal generator in a geographical area containing a plurality of wireless signal generators;
providing the first variable identifier through a user interface of the mobile electronic device;
associating the first variable identifier with a first point of interest and storing the association;
receiving a second variable identifier and a second unique identifier from a second wireless signal generator among the plurality of wireless signal generators; and
automatically associating the second variable identifier with the first point of interest, based on whether or not the second variable identifier is the same, at least in part, as the first variable identifier, and storing the association.

14. The method of claim 13, further comprising, if the mobile electronic device leaves the geographical area and then re-enters the geographical area to thereby receive the second variable identifier and the second unique identifier from the second wireless signal generator, providing information stating that the mobile electronic device is located at the first point of interest through the user interface, or providing a service that is related to the first point of interest.

15. The method of claim 13, wherein each of the first variable identifier and the second variable identifier includes a sequence including at least one letter and/or at least one number.

16. The method of claim 13, wherein automatically associating the second variable identifier with the first point of interest, based on whether or not the second variable identifier is the same, at least in part, as the first variable identifier, and storing the association comprises, if at least 50% of a sequence of the first variable identifier is the same as a sequence of the second variable identifier, automatically associating the second variable identifier with the first point of interest and storing the association.

17. The method of claim 13, wherein providing the first variable identifier through the user interface of the mobile electronic device comprises displaying the first variable identifier on a display of the user interface.

18. The method of claim 13, further comprising:
receiving, in a state in which the first variable identifier and the first unique identifier are not received from the first wireless signal generator, the second variable identifier and the second unique identifier from the second wireless signal generator;
receiving the third variable identifier and the third unique identifier from the third wireless signal generator among the plurality of wireless signal generators; and
automatically associating the third variable identifier with the first point of interest, based on whether or not the third variable identifier is the same, at least in part, as the second variable identifier, and storing the association.

19. The method of claim 13, further comprising, if the first variable identifier and the first unique identifier are not received from the first wireless signal generator, and if the second variable identifier and the second unique identifier are not received from the second wireless signal generator, stopping associating the first point of interest with a new wireless signal generator in the geographical area and storing that the association is stopped.

20. The method of claim 13, wherein automatically associating the second variable identifier with the first point of interest, based on whether or not the second variable identifier is the same, at least in part, as the first variable identifier, and storing the association comprises, if the second variable identifier is the same, at least in part, as the first variable identifier, automatically associating the second variable identifier with the first point of interest, based on at least one of a signal strength of the second wireless signal generator or information on a cell that contains the second wireless signal generator, and storing the association.
